(19) United States
(12) Patent Application Publication
(10) Pub. No.: US 2026/0227199 A1
(43) Pub. Date: Aug. 6, 2026

(54) ELEVATION MAP CONSTRUCTION METHOD AND SYSTEM FOR LEGGED ROBOT, AND STORAGE MEDIUM

(71) Applicant: HangZhou YuShu TECHNOLOGY CO.,LTD., Hangzhou, Zhejiang (CN)

(72) Inventors: Xingxing WANG, Hangzhou, Zhejiang (CN); Lingbo MENG, Hangzhou, Zhejiang (CN)

(21) Appl. No.: 19/159,080

(22) PCT Filed: Jun. 29, 2023
(86) PCT No.: PCT/CN2023/103707

§ 371 Date: Aug. 22, 2025

(30) Foreign Application Priority Data
Feb. 24, 2023 (CN) 202310202525.2

(51) Int. Cl. G01C 21/00; B62D 57/032; G01S 17/89; G06T 17/05

(52) U.S. Cl. CPC G01C 21/3826; G01S 17/89; G06T 17/05; B62D 57/032

(57) ABSTRACT

An elevation map construction method for motion planning of a legged robot includes: constructing a motion distortion removal model, a point cloud filtering model and an elevation map model, performing pose transformation on original measurement point data to obtain a current frame of point clouds with motion distortion removed, and then processing the current frame of point clouds to remove points unrelated to environmental information therein to obtain preprocessed point clouds; and constructing an elevation map for the motion planning of the legged robot by using the processed point clouds and the body odometer pose data of the legged robot. The solution is scientific, reasonable, and feasible, can effectively improve the accuracy of the elevation map, can facilitate promotion, and can achieve the accurate navigation of the robot. Moreover, the elevation map can be centered on the legged robot and move with the robot in real time.

### TECHNICAL FIELD

The present invention relates to an elevation map construction method and system for a legged robot, and a storage medium, belonging to the technical field of elevation map construction.

### BACKGROUND

To enable legged robots to achieve precise path planning and motion control in their operating environments, it is required to construct a map of environmental information using data fed back from sensors. In complex environments, an accurate environmental map allows legged robots to navigate safely and efficiently while avoiding obstacles. Through sensors such as laser radar and depth cameras, robots can measure surrounding environmental terrains, thus constructing complete environmental maps through relevant map construction algorithms.

Current mainstream environmental map construction methods, such as laser SLAM and visual SLAM algorithms, typically establish global maps in a world coordinate system, which require a precise global localization system. However, these localization methods impose specific environmental requirements and are prone to failure otherwise. For example, the laser SLAM algorithm requires sufficient geometric features in the environment to enable effective constraint matching between two frames of laser point clouds; the visual SLAM algorithm requires adequate textural features in camera images without causing image overexposure or motion-induced blur. In addition, these map construction methods generally incur excessive computational overhead and memory occupation, making real-time computation infeasible on embedded computers commonly used in legged robots. Moreover, the formats of the constructed maps are often not directly applicable to motion planning of robots.

To solve the disadvantages of the global map construction methods, researchers at Swiss Federal Institute of Technology in Zurich proposed a local elevation map construction method ElevationMapping centered on legged robots. This method utilizes only the kinematic odometer of the legged robot for localization and updates the elevation map with sensor measurements, thus achieving a satisfactory map construction effect. However, this method still suffers from significant computational overhead and memory occupation. Moreover, when point clouds acquired by robot-mounted sensors are sparse, the maps established by adopting this method exhibit excessive sparsity, severely hindering foothold planning for legged robots.

Further, Chinese Patent Publication No. CN111596665A discloses a dense elevation map construction method, belonging to the technical field of dense elevation map construction. The construction method specifically includes: estimating laser radar measurements by using a Gaussian distribution model, mapping the measurements to corresponding grids in a local map to perform multi-frame data fusion, updating a map grid covariance according to robot pose information, adaptively moving the local map, and removing dynamic obstacles to form a complete local dense map.

Since the timestamps of each point collected by the sensors differ, the pose of the sensor coordinate system in the world coordinate system at the corresponding timestamp of each point also varies. Therefore, a frame of point clouds originally collected contains distortion caused by sensor motion, i.e., motion distortion. However, the above solution does not solve the problem of motion distortion. If motion distortion is not removed, it will affect the accuracy of the elevation map, thus not achieving precise robot navigation and hindering the popularization.

Further, the above solution does not disclose how to process measurement points unrelated to environmental information. If the points unrelated to the environmental information are not removed, it will also affect the accuracy of the elevation map.

The information disclosed in the background is only for understanding the background of the concept of the present invention, so it may include information that does not constitute the existing technology.

### SUMMARY

To solve the above problems or one of the above problems, a first purpose of the present invention is to provide an elevation map construction method for a robot, which includes: constructing a motion distortion removal model, a point cloud filtering model, and an elevation map model, performing pose transformation on original measurement point data to obtain a current frame of point clouds with motion distortion removed, then performing processing on the current frame of point clouds to remove points unrelated to environmental information therein to obtain preprocessed point clouds, and constructing an elevation map for the motion planning of the legged robot by using the preprocessed point clouds and body odometer pose data. The solution is scientific, reasonable, and feasible, which can effectively improve the accuracy of the elevation map, facilitate popularization, and achieve precise robot navigation.

To solve the above problems or one of the above problems, a second purpose of the present invention is to provide an elevation map construction method for a robot, which includes: transforming a measurement point from a sensor coordinate system to a world coordinate system through body odometer pose estimate and pose transformation obtained through calibration from a body coordinate system to the sensor coordinate system, removing motion distortion, and constructing a robot-centered dense elevation map for the motion planning of the legged robot by using the processed data.

To solve the above problems or one of the above problems, a third purpose of the present invention is to provide an elevation map construction system for a robot, which includes: constructing a motion distortion removal module, a point cloud filtering module, and an elevation map module, performing processing on original measurement point data, transforming the original measurement point data from a sensor coordinate system at a certain time to a sensor coordinate system at a unified time to obtain a current frame of point clouds with motion distortion removed, then performing processing on the current frame of point clouds to remove points unrelated to environmental information therein to obtain preprocessed point clouds, and constructing an elevation map for the motion planning of the legged robot by using the processed point clouds and the body odometer pose data of the legged robot. The solution is scientific, reasonable, and feasible, which can effectively improve the accuracy of the elevation map, facilitate popularization, and achieve precise robot navigation.

To solve the above problems or one of the above problems, a fourth purpose of the present invention is to provide an elevation map construction method and system for a legged robot, and a storage medium, which have the advantages of high computational efficiency, high map construction accuracy, and good map construction effect.

To achieve one of the above purposes, a first technical solution of the present invention is as follows:

An elevation map construction method for motion planning of a legged robot, including the following steps:
step one: acquiring original measurement point data of a map planning area;
step two: performing pose transformation on the original measurement point data by using a preconstructed motion distortion removal model to obtain a current frame of point clouds with motion distortion removed;
step three: performing processing on the current frame of point clouds through a preconstructed point cloud filtering model to remove points unrelated to environmental information therein to obtain preprocessed point clouds, where the points unrelated to the environmental information include a body point cloud or/and a leg point cloud or/and a noise point cloud;
step four: performing processing on the preprocessed point clouds by using a preconstructed elevation map model according to body odometer and/or visual odometer and/or laser odometer pose data to obtain a grid elevation value; and step five: establishing or updating grids in the map planning area according to the grid elevation value to achieve elevation map construction for the motion planning of the legged robot.

After continuous exploration and testing, by constructing the motion distortion removal model, the point cloud filtering model, and the elevation map model, performing the pose transformation on the original measurement point data to obtain the current frame of point clouds with motion distortion removed, then performing processing on the current frame of point clouds to remove points unrelated to environmental information therein to obtain preprocessed point clouds, and constructing the elevation map for the motion planning of the legged robot by using the preprocessed point clouds and the body odometer pose data of the legged robot, the solution is scientific, reasonable, and feasible, which can effectively improve the accuracy of the elevation map, facilitate popularization, and achieve precise robot navigation.

As a preferred technical measure,
in step two, a method for the motion distortion removal model to perform motion distortion removal on the original measurement point data includes the following steps:
step 1: putting the current frame of point clouds with a timestamp into a point cloud queue cloudQueue, and putting a robot odometer pose with a timestamp into an odometer queue odomQueue;
step 2: in a case that a current point cloud queue is not empty, traversing the odometer queue from front to back, and maintaining a queue first frame timestamp of the odometer queue aligned with a point cloud start point timestamp, i.e., in a case that the queue first frame timestamp of the odometer queue is smaller than the point cloud start point timestamp, removing the queue first frame timestamp out of the queue;
step 3: performing ordering on the current frame of point clouds according to a time sequence, where a timestamp of a first point, i.e., a start point, is denoted as tₛ, and a timestamp of a last point, i.e., an end point, is denoted as tₑ;
using the timestamp of the end point as a timestamp of the current frame of point clouds, denoted as t_{c}=tₑ;
step 4: traversing the odometer queue from front to back, and finding out adjacent two frames of odometer poses just before and after the point cloud timestamp, where the adjacent two frames of odometer poses are respectively

$${T}_{b}^{w} ( {t}_{k} ) and {T}_{b}^{w} ( {t}_{k + 1} ) ,$$

satisfying tₖ≤t_{c}<tₖ₊₁;
then computing a robot odometer pose at the point cloud timestamp by using a linear interpolation method, where an expression thereof is:

$${T}_{b}^{w} ( {t}_{c} ) = \frac{{t}_{k + 1} - {t}_{c}}{{t}_{k + 1} - {t}_{k}} {T}_{b}^{w} ( {t}_{k} ) + ( 1 - \frac{{t}_{k + 1} - {t}_{c}}{{t}_{k + 1} - {t}_{k}} ) {T}_{b}^{w} ( {t}_{k + 1} )$$

step 5: traversing each original measurement point in the point clouds backwards from the start point according to the timestamp; performing linear interpolation to obtain a robot odometer pose at a time corresponding to the original measurement point, denoted as

$${T}_{b}^{w} ( {t}_{p} ) ;$$

and
step 6: transforming a currently traversed original measurement point

$${p}_{a}^{s}$$

from a sensor coordinate system at a time tₚ to a sensor coordinate system at a unified time t_{c} through pose transformation, so as to achieve motion distortion removal, where a computation formula thereof is:

$${p}_{b}^{s} = {[ {T}_{b}^{w} ( {t}_{c} ) {T}_{s}^{b} ]}^{- 1} {T}_{b}^{w} ( {t}_{p} ) {T}_{s}^{b} {p}_{a}^{s} .$$

As a preferred technical measure,
in step three, a method for the point cloud filtering model to perform processing on the current frame of point clouds

$${P}_{b}^{s}$$

includes the following steps:
for a point

$${p}^{s} = {[ {p}_{x}^{s} , {p}_{y}^{s} , {p}_{z}^{s} ]}^{T} ∈ {P}_{b}^{S}$$

in the current frame of point clouds with motion distortion removed, computing polar coordinates thereof in a sensor coordinate system {S}:

$$\{ \begin{matrix}{s}_{r} = \sqrt{{( {p}_{x}^{s} )}^{2} + {( {p}_{y}^{s} )}^{2} + {( {p}_{z}^{s} )}^{2}} \\ {s}_{p} = arccos ( {p}_{z}^{s} / {s}_{r} ) \\ {s}_{a} = arctan ( {p}_{y}^{s} / {p}_{x}^{s} )\end{matrix}$$

where sᵣ is a length of a vector p^{s}, sₚ is an included angle between the vector p^{s} and a positive direction of a Z-axis of the sensor coordinate system, and s_{α} is an included angle between a projection vector of the vector p^{s} in an XY plane of the sensor coordinate system and a positive direction of an X-axis;
in a polar coordinate system, projecting all points onto a spherical surface with sᵣ=1, and then selecting a specific rectangular area of the spherical surface to remove a noise point cloud and a trailing point cloud projected thereto, where an expression thereof is:

$$\{ \begin{matrix}{s}_{p} ∈ [ {s}_{{p}_{min}} , {s}_{{p}_{max}} ] \\ {s}_{a} ∈ [ {s}_{{a}_{min}} , {s}_{{a}_{min}} ]\end{matrix}$$

in order to remove point clouds of legs of the legged robot, based on the forward kinematics of the robot, computing a position of each joint in the body coordinate system from angles of motor joints, and then transforming the position into the sensor coordinate system;
letting positions of a knee joint and a foot end in the sensor coordinate system be respectively A₀ and B₀, and firstly projecting the positions onto a spherical surface with a radius of 1 in the sensor coordinate system {S}; letting two points after projection be respectively A and B, then obtaining:

$$SA = \frac{{SA}_{o}}{\vert {SA}_{o} \vert}$$

$$SB = \frac{{SB}_{o}}{\vert {SB}_{o} \vert}$$

constructing a set of standard orthogonal bases from vectors SA and SB:

$$\{ \begin{matrix}{b}_{x} = S A \\ {b}_{z} = S N = S A \times S B \\ {b}_{y} = S F = {b}_{z} \times S A\end{matrix}$$

letting a foot of a perpendicular of a point P projected onto an XY plane of the standard orthogonal bases be H=[hₓ, h_{y}, h_{z}]^{T}, then the foot of the perpendicular being:

$$\{ \begin{matrix}{h}_{x} = SP \cdot SA \\ {h}_{y} = SP \cdot SF \\ {h}_{z} = SP \cdot SN\end{matrix}$$

under the standard orthogonal bases, computing spherical coordinates (1, θ, φ) of a laser point P:

$$\{ \begin{matrix}θ = ∠ NSP = arccos ( SP \cdot SN ) \\ ϕ = ∠ ASH = arctan ( {h}_{y} / {h}_{x} )\end{matrix}$$

where a projection of a lower leg link approximates a rectangle on a normalized spherical surface, and then A and B are central axes of the rectangle;
letting the maximum width of the lower leg link after projection be b and the maximum length of the lower leg link be l, and then determining whether the point P is within the rectangle range through the following formula:

$$\{ \begin{matrix}0.5 π - θ ∈ ( - 0.5 b , 0.5 b ) \\ ϕ ∈ ( 0 , l )\end{matrix}$$

in a case that the measurement point is within the rectangle, considering that the measurement point is a leg point, and removing the measurement point from the point cloud to achieve leg point cloud removal.

As a preferred technical measure,
in step four, the elevation map model treats each measurement point of the preprocessed point cloud as a measurement to establish or update the grids in the map planning area, and a method for the elevation map model to perform processing on the preprocessed point clouds includes:
for each grid in the map planning area, representing an estimated elevation value of the grid by using a Gaussian distribution model:

$$\hat{h} ∼ N ( {μ}_{\hat{h}} , {σ}_{\hat{h}}^{2} )$$

where μ_{ĥ} and

$${σ}_{\hat{h}}^{2}$$

are respectively a mean value and a variance of a Gaussian distribution;
for a measurement point p^{s} in the sensor coordinate system, transforming the measurement point from the sensor coordinate system to a world coordinate system by using a body odometer pose estimate

$$( {R}_{b}^{w} , {t}_{b}^{w} )$$

and a pose transformation

$$( {R}_{s}^{b} , {t}_{s}^{b} )$$

obtained through calibration from the body coordinate system to the sensor coordinate system:

$${p}^{w} = {R}_{b}^{w} ( {R}_{s}^{b} {p}^{s} + {t}_{s}^{b} ) + {t}_{b}^{w}$$

determining a formula group by using a map index, and mapping the measurement point from the world coordinate system to obtain a corresponding two-dimensional array index

$$( {I}_{x}^{a} , {I}_{y}^{a} )$$

thereof, where a corresponding elevation value thereof is a z-axis component of a measurement point

$${p}^{w} = ( {p}_{x}^{w} , {p}_{y}^{w} , {p}_{z}^{w} ) ,$$

i.e., an elevation measurement value of a current grid;
establishing a projection matrix Mₚ=[0,0,1] to obtain a current elevation measurement value:

$$\tilde{h} = {p}_{z}^{w} = {M}_{p} {p}^{w} = {M}_{p} [ {R}_{b}^{w} ( {R}_{s}^{b} {p}^{s} + {t}_{s}^{b} ) + {t}_{b}^{w} ]$$

where a pose transformation from the sensor coordinate system to a robot coordinate system is a fixed value obtained through calibration;
in a case that the measurement point p^{s} in the sensor coordinate system satisfies a Gaussian distribution, variance propagation of an elevation estimate thereof mainly depends on a variance of a sensor measurement p^{s}, a variance of a robot odometer rotation

$${R}_{b}^{w} ,$$

and a variance of a rovou odometer translation

$${t}_{b}^{w} ;$$

performing derivation to obtain Jacobian matrices of the elevation measurement value \tilde{h} with respect to p^{s},

$${R}_{b}^{w} , and {t}_{b}^{w} :$$

$${J}_{p} = \frac{\partial \tilde{h}}{\partial {p}^{s}}$$

$${J}_{R} = \frac{\partial \tilde{h}}{\partial {R}_{b}^{w}}$$

$${J}_{t} = \frac{\partial \tilde{h}}{\partial {t}_{b}^{w}}$$

then, computing a variance of the current elevation measurement value through covariance propagation:

$${σ}_{\tilde{h}}^{2} = {J}_{p} {\sum }_{p} {J}_{p}^{T} + {J}_{R} {\sum }_{R} {J}_{R}^{T} + {J}_{t} {\sum }_{t} {J}_{t}^{T}$$

where Σₚ is a covariance matrix of the measurement point in the sensor coordinate system, and a magnitude thereof depends on a sensor measurement noise model; Σ_{R} is a covariance matrix of the robot odometer rotation; Σₜ is a covariance matrix of the robot odometer translation;
thus obtaining a Gaussian distribution of the current elevation measurement:

$$\tilde{h} ∼ N ( {μ}_{\tilde{h}} , {σ}_{\tilde{h}}^{2} )$$

fusing the current elevation measurement into the elevation estimate of the current grid by using a Kalman filtering method to obtain an updated grid elevation value:

$${μ}_{\hat{h}} = \frac{{σ}_{\hat{h}}^{2} {μ}_{\tilde{h}} + {σ}_{\tilde{h}}^{2} {μ}_{\hat{h}}}{{σ}_{\hat{h}}^{2} + {σ}_{\tilde{h}}^{2}}$$

$${σ}_{\hat{h}}^{2} = \frac{{σ}_{\hat{h}}^{2} {σ}_{\tilde{h}}^{2}}{{σ}_{\hat{h}}^{2} + {σ}_{\tilde{h}}^{2}}$$

finally completing the elevation map construction for the motion planning of the legged robot according to the grid elevation value.

To achieve one of the above purposes, a second technical solution of the present invention is as follows: an elevation map construction method for motion planning of a legged robot, including the following steps:
S1: acquiring a measurement point p^{s} in a sensor coordinate system collected by a laser radar, and transforming the measurement point from the sensor coordinate system to a world coordinate system by using a body odometer pose estimate

$$( {R}_{b}^{w} , {t}_{b}^{w} )$$

and a pose transformation

$$( {R}_{s}^{b} , {t}_{s}^{b} )$$

obtained through calibration from a body coordinate system to the sensor coordinate system, where a world coordinate value of the measurement point is p^{w}:

$${p}^{w} = {R}_{b}^{w} ( {R}_{s}^{b} {p}^{s} + {t}_{s}^{b} ) + {t}_{b}^{w}$$

S2: mapping the measurement point from the world coordinate system to a corresponding grid thereof in an elevation map, where a corresponding elevation value thereof is a z-axis component of a measurement point

$${p}^{w} = ( {p}_{x}^{w} , {p}_{y}^{w} , {p}_{z}^{w} ) ,$$

i.e., an elevation measurement value of a current grid, and the elevation measurement value satisfies a Gaussian distribution

$$\tilde{h} ∼ N ( {μ}_{\tilde{h}} , {σ}_{\tilde{h}}^{2} ) ;$$

and constructing a projection matrix Mₚ=[0,0,1] to obtain a current elevation measurement mean value:

$${μ}_{\tilde{h}} = {M}_{p} {p}^{w} = {M}_{p} [ {R}_{b}^{w} ( {R}_{s}^{b} {p}^{s} + {t}_{s}^{b} ) + {t}_{b}^{w} ]$$

computing a variance of a current elevation measurement value from covariance propagation:

$${σ}_{\tilde{h}}^{2} = {J}_{p} {\sum }_{p} {J}_{p}^{T} + {J}_{R} {\sum }_{R} {d}_{R}^{T} + {J}_{t} {\sum }_{t} {J}_{t}^{T}$$

where Jₚ, J_{R}, and Jₜ are Jacobian matrices of the elevation measurement value \tilde{h} with respect to p^{s},

$${R}_{b}^{w} , and {t}_{b}^{w} ;$$

Σₚ is a covariance matrix of the measurement point in the sensor coordinate system; Σ_{R} is a covariance matrix of a robot odometer rotation; Σₜ is a covariance matrix of a robot odometer translation;
S3: constructing a Gaussian distribution of the current elevation measurement value according to variances of the current elevation measurement mean value and the current elevation measurement value;
in a case that elevation estimates of grids satisfy the Gaussian distribution

$$\tilde{h} ∼ N ( {μ}_{\tilde{h}} , {σ}_{\tilde{h}}^{2} ) ,$$

fusing the current elevation measurement into an elevation estimate of the current grid by computing a normalized product of two Gaussian distributions to obtain an updated elevation estimate:

$${μ}_{\hat{h}} = \frac{{σ}_{\hat{h}}^{2} {μ}_{\tilde{h}} + {σ}_{\tilde{h}}^{2} {μ}_{\hat{h}}}{{σ}_{\hat{h}}^{2} + {σ}_{\tilde{h}}^{2}}$$

$${σ}_{\hat{h}}^{2} = \frac{{σ}_{\hat{h}}^{2} {σ}_{\tilde{h}}^{2}}{{σ}_{\hat{h}}^{2} + {σ}_{\tilde{h}}^{2}}$$

S4: constructing a dense elevation map for the motion planning of the legged robot according to the updated elevation estimate.

The elevation map construction method for the motion planning of the legged robot provided in the present invention transforms the measurement from the sensor coordinate system to the world coordinate system through body odometer pose estimate and pose transformation obtained through calibration from the body coordinate system to the sensor coordinate system, removes motion distortion, and constructs a robot-centered dense elevation map for the motion planning of the legged robot by using the processed data. Compared with the traditional method, the present invention has the advantages of high computational efficiency, high map construction accuracy, and good map construction effect, and can implement real-time high-efficiency environmental elevation map construction on an embedded platform, and the elevation map can be centered on the legged robot to move with the legged robot in real time.

As a preferred technical measure,
mapping the measurement point from the world coordinate system to a corresponding grid thereof in an elevation map, i.e., mapping the measurement point p^{w} from the world coordinate system to obtain a two-dimensional array index

$$( {I}_{x}^{a} , {I}_{y}^{a} )$$

to which the corresponding grid thereof in the elevation map belongs, includes the following steps:
step one: letting the measurement point in the world coordinate system be

$${p}^{w} = [ {p}_{x}^{w} , {p}_{y}^{w} , {p}_{z}^{w} ]$$

respectively dividing x and y components thereof by a map resolution r, and performing rounding-down to obtain a 2D integer index of the corresponding grid of the measurement point in the world coordinate system:

$$\{ \begin{matrix}{I}_{x}^{w} = ⌊ {p}_{x}^{w} / r ⌋ \\ {I}_{y}^{w} = ⌊ {p}_{y}^{w} / r ⌋\end{matrix}$$

step two: letting a 2D integer index of an origin of a current map coordinate system in the world coordinate system be

$$[ {I}_{{m}_{x}}^{w} , {I}_{{m}_{y}}^{w} ] ,$$

and computing a 2D integer index of a corresponding grid of the measurement point in a map coordinate system:

$$\{ \begin{matrix}{I}_{x}^{m} = {I}_{x}^{w} - {I}_{{m}_{x}}^{w} \\ {I}_{y}^{m} = {I}_{y}^{w} - {I}_{{m}_{y}}^{w}\end{matrix}$$

step three: letting the elevation map be a grid map with a size of N×N, and determining whether a current point is within an elevation map range by determining whether an index of the current point simultaneously satisfies the following two conditions:

$$\{ \begin{matrix}{I}_{x}^{m} ∈ [ 0 , N ) \\ {I}_{y}^{m} ∈ [ 0 , N )\end{matrix}$$

step four: in a case that the measurement point simultaneously satisfies the two conditions, i.e., the measurement point is within the map range, performing a modulo operation on the 2D integer index in the world coordinate system to a map size N, and mapping the measurement point to a two-dimensional array index stored in a computer:

$$\{ \begin{matrix}{I}_{x}^{a} = {I}_{x}^{w} m o {d}^{N} \\ {I}_{y}^{a} = {I}_{y}^{w} {mod}^{N}\end{matrix}$$

step five: changing an index mapping step to a binary form with high computational efficiency, i.e., changing the modulo operation “mod” to binary bitwise and operation “&”, by setting the length and width of the elevation map to exponents of 2 with the same magnitude, i.e., N=2ⁿ:

$$\{ \begin{matrix}{I}_{x}^{a} = {I}_{x}^{w} \& ( {2}^{n} - 1 ) \\ {I}_{y}^{a} = {I}_{y}^{w} \& ( {2}^{n} - 1 )\end{matrix} .$$

The present invention constructs a 2.5D elevation map model based on a circular buffer, which not only can efficiently map a spatial point to a corresponding elevation map grid and perform indexing, but also can rapidly move the map.

Therefore, the method provided in the present invention has the advantages of very low CPU occupation and memory occupation when running in an embedded computer, and can construct a high-accuracy dense elevation map around the legged robot in real time, thus providing environmental perception information for the motion planning of the legged robot.

As a preferred technical measure,
performing motion distortion removal on the measurement point p^{s} in the sensor coordinate system includes the following steps:
A1: putting a current frame of point clouds with a timestamp into a point cloud queue, and putting a robot odometer pose with a timestamp into an odometer queue; in a case that a current point cloud queue is not empty, traversing the odometer queue from front to back, and maintaining a queue first frame timestamp of the odometer queue aligned with a point cloud start point timestamp;
A2: for the current frame of point clouds, letting a timestamp of a start point be tₛ, letting a timestamp of an end point be tₑ, and using the timestamp of the end point as a timestamp of the current frame of point clouds, denoted as t_{c}=tₑ;
A3: traversing the odometer queue from front to back, and finding out adjacent two frames of odometer poses just before and after a point cloud timestamp, where the adjacent two frames of odometer poses are respectively

$${T}_{b}^{w} ( {t}_{k} ) and {T}_{b}^{w} ( {t}_{k + 1} ) ,$$

satisfying tₖ≤t_{c}<tₖ₊₁; then computing a robot odometer pose at the point cloud timestamp through a linear interpolation method:

$${T}_{b}^{w} ( {t}_{c} ) = \frac{{t}_{k + 1} - {t}_{c}}{{t}_{k + 1} - {t}_{k}} {T}_{b}^{w} ( {t}_{k} ) + ( 1 - \frac{{t}_{k + 1} - {t}_{c}}{{t}_{k + 1} - {t}_{k}} ) {T}_{b}^{w} ( {t}_{k + 1} ) ;$$

A4: traversing each point in the point cloud queue backwards from the start point according to the timestamp, where a currently traversed original measurement point is

$${p}_{a}^{s}$$

and a timestamp thereof is tₚ, and performing linear interpolation on the adjacent two frames of odometer poses at the time to obtain a robot odometer pose at a time corresponding to the measurement point, denoted as

$${T}_{b}^{w} ( {t}_{p} ) ;$$

A5: transforming the original measurement point

$${p}_{a}^{s}$$

from the sensor coordinate system at a time tₚ to a sensor coordinate system at a unified time corresponding to the timestamp t_{c} of the current frame of point clouds through pose transformation:

$${p}_{b}^{s} = {[ {T}_{b}^{w} ( {t}_{c} ) {T}_{s}^{b} ]}^{- 1} {T}_{b}^{w} ( {t}_{p} ) {T}_{s}^{b} {p}_{a}^{s}$$

thus obtaining a current frame of point clouds

$${P}_{b}^{s}$$

with motion distortion removed.

As a preferred technical measure,
performing trailing point cloud removal on the current frame of point clouds

$${P}_{b}^{s}$$

includes the following steps:
B1: computing polar coordinates of a point p^{s} in the point clouds in the sensor coordinate system:

$$\{ \begin{matrix}{s}_{r} = \sqrt{{( {p}_{x}^{s} )}^{2} + {( {p}_{y}^{s} )}^{2} + {( {p}_{z}^{s} )}^{2}} \\ {s}_{p} = arccos ( {p}_{z}^{s} / {s}_{r} ) \\ {s}_{a} = arctan ( {p}_{y}^{s} / {p}_{x}^{s} )\end{matrix}$$

where sᵣ is a length of a vector p^{s}, sₚ is an included angle between the vector p^{s} and a positive direction of a Z-axis of the sensor coordinate system, and s_{α} is an included angle between a projection vector of the vector p^{s} in an XY plane of the sensor coordinate system and a positive direction of an X-axis;
B2: in a polar coordinate system, projecting all points onto a spherical surface with sᵣ=1, and then selecting a specific rectangular area of the spherical surface to remove a trailing point cloud projected thereto:

$$\{ \begin{matrix}{s}_{P} ∈ [ {s}_{{p}_{min}} , {s}_{{p}_{max}} ] \\ {s}_{a} ∈ [ {s}_{{a}_{min}} , {s}_{{a}_{min}} ]\end{matrix}$$

performing leg point cloud removal on the current frame of point clouds

$${P}_{b}^{s}$$

includes the following steps:
C1: projecting a position Aₒ, of a knee joint in the sensor coordinate system and a position Bₒ of a foot end in the sensor coordinate system onto a spherical surface with a radius of 1 in the sensor coordinate system; letting two points after projection be respectively A and B, then obtaining:

$$SA = \frac{{SA}_{o}}{\vert {SA}_{o} \vert}$$

$$SB = \frac{{SB}_{o}}{\vert {SB}_{o} \vert}$$

constructing a set of standard orthogonal bases from vectors SA and SB:

$$\{ \begin{matrix}{b}_{x} = SA \\ {b}_{z} = SN = SA \times SB \\ {b}_{y} = SF = {b}_{z} \times SA\end{matrix}$$

C2: letting a foot of a perpendicular of a point P projected onto an XY plane of the standard orthogonal bases be H=[hₓ, h_{y}, h_{z}]^{T}, then the foot of the perpendicular being:

$$\{ \begin{matrix}{h}_{x} = SP \cdot SA \\ {h}_{y} = SP \cdot SF \\ {h}_{z} = SP \cdot SN\end{matrix}$$

under the standard orthogonal bases, computing spherical coordinates (1, θ, φ) of a laser point P:

$$\{ \begin{matrix}θ = ∠ NSP = arc cos ( SP \cdot SN ) \\ ϕ = ∠ ASH = arc tan ( {h}_{y} / {h}_{x} )\end{matrix}$$

C3: assuming that a projection of a leg link is a rectangle on a normalized spherical surface, determining whether the point P is within the rectangle range through the following formula:

$$\{ \begin{matrix}0.5 π - θ ∈ ( - 0.5 b , 0.5 b ) \\ ϕ ∈ ( 0 , l )\end{matrix}$$

where b is the maximum width of the leg link after projection and/is the maximum length of the leg link after projection; in a case that the point P is within the rectangle range, removing the point P.

To achieve one of the above purposes, a third technical solution of the present invention is as follows:

An elevation map construction method for motion planning of a legged robot, including the following steps:
acquiring original measurement point data of a map planning area;
performing pose transformation on the original measurement point data to obtain a current frame of point clouds with motion distortion removed;
performing processing on the current frame of point clouds to remove points unrelated to environmental information therein to obtain preprocessed point clouds, where
the points unrelated to the environmental information include a body point cloud or/and a leg point cloud or/and a noise point cloud;
performing processing on the preprocessed point clouds according to body odometer and/or visual odometer and/or laser odometer pose data to obtain a grid elevation value; and
establishing or updating grids in the map planning area according to the grid elevation value to achieve elevation map construction for the motion planning of the legged robot.

After continuous exploration and testing, by performing the pose transformation on the original measurement point data to obtain the current frame of point clouds with motion distortion removed, then performing processing on the current frame of point clouds to remove points unrelated to environmental information therein to obtain preprocessed point clouds, and constructing the elevation map for the motion planning of the legged robot by using the preprocessed point clouds and the body odometer pose data of the legged robot, the solution is scientific, reasonable, and feasible, which can effectively improve the accuracy of the elevation map, facilitate popularization, and achieve precise robot navigation.

To achieve one of the above purposes, a fourth technical solution of the present invention is as follows: an elevation map construction system for motion planning of a legged robot, including a laser radar, a motion distortion removal module, a point cloud filtering module, an elevation map module, one or more processors, and a storage apparatus, where
the laser radar is configured to acquire original measurement point data;
the motion distortion removal module is configured to perform processing on the original measurement point data according to transformation characteristics of a reference coordinate system to transform the original measurement point data from a sensor coordinate system at a certain time to a sensor coordinate system at a unified time to obtain a current frame of point clouds with motion distortion removed;
the point cloud filtering module is configured to perform processing on the current frame of point clouds to remove points unrelated to environmental information therein to obtain preprocessed point clouds;
the elevation map module is configured to perform processing on the preprocessed point clouds to obtain a grid elevation value; and updating corresponding grids of the preprocessed point clouds in an elevation map;
the storage apparatus is configured to store a program of one or more modules;
the program, when executed by the one or more processor, causes the one or more processor to implement the elevation map construction method for the motion planning of the legged robot described above.

After continuous exploration and testing, by setting the motion distortion removal model, the point cloud filtering model, and the elevation map model, performing processing on the original measurement point data, transforming the original measurement point data in the sensor coordinate system at the certain time to the sensor coordinate system at the unified time to obtain the current frame of point clouds with motion distortion removed, then performing processing on the current frame of point clouds to remove points unrelated to environmental information therein to obtain preprocessed point clouds, and constructing the elevation map for the motion planning of the legged robot by using the preprocessed point clouds and the body odometer pose data of the legged robot, the solution is scientific, reasonable, and feasible, which can effectively improve the accuracy of the elevation map, facilitate popularization, and achieve precise robot navigation.

Further, compared with the traditional method, the present invention has the advantages of high computational efficiency, high map construction accuracy, and good map construction effect, and can implement real-time high-efficiency environmental elevation map construction on an embedded platform, and the elevation map can be centered on the legged robot to move with the legged robot in real time.

To achieve one of the above purposes, a fifth technical solution of the present invention is as follows:

A computer-readable storage medium, having a computer program stored therein, where the program, when executed by a processor, implements the elevation map construction method for the motion planning of the legged robot described above.

The present has the following beneficial effects:

After continuous exploration and testing, by performing the pose transformation on the original measurement point data to obtain the current frame of point clouds with motion distortion removed, then performing processing on the current frame of point clouds to remove points unrelated to environmental information therein to obtain preprocessed point clouds, and constructing the elevation map for the motion planning of the legged robot by using the preprocessed point clouds and the body odometer pose data of the legged robot, the solution is scientific, reasonable, and feasible, which can effectively improve the accuracy of the elevation map, facilitate popularization, and achieve precise robot navigation.

Further, the elevation map construction method for the legged robot transforms the measurement point from the sensor coordinate system to the world coordinate system through body odometer pose estimate and pose transformation obtained through calibration from the body coordinate system to the sensor coordinate system, removes motion distortion, and constructs the robot-centered dense elevation map for the motion planning of the legged robot by using the processed data.

Further, after continuous exploration and testing, by setting the motion distortion removal model, the point cloud filtering model, and the elevation map model, performing processing on the original measurement point data, transforming the original measurement point data in the sensor coordinate system at the certain time to the sensor coordinate system at the unified time to obtain the current frame of point clouds with motion distortion removed, then performing processing on the current frame of point clouds to remove points unrelated to environmental information therein to obtain preprocessed point clouds, and constructing the elevation map for the motion planning of the legged robot by using the preprocessed point clouds and the body odometer pose data of the legged robot, the solution is scientific, reasonable, and feasible, which can effectively improve the accuracy of the elevation map, facilitate popularization, and achieve precise robot navigation.

Further, compared with the traditional method, the present invention has the advantages of high computational efficiency, high map construction accuracy, and good map construction effect, and can implement real-time high-efficiency environmental elevation map construction on an embedded platform, and the elevation map can be centered on the legged robot to move with the legged robot in real time.

### DESCRIPTION OF THE DRAWINGS

FIG. 1 is a first flowchart of an elevation map construction method according to the present invention;

FIG. 2 is a second flowchart of an elevation map construction method according to the present invention;

FIG. 3 is a schematic diagram of a coordinate system according to the present invention;

FIG. 4 is a schematic diagram during leg point cloud removal in a spherical coordinate system according to the present invention;

FIG. 5 is a schematic diagram before noise point cloud and leg point cloud removal according to the present invention;

FIG. 6 is a schematic diagram after noise point cloud and leg point cloud removal according to the present invention;

FIG. 7 is a schematic diagram during elevation map indexing according to the present invention;

FIG. 8 is a schematic diagram during elevation map movement according to the present invention;

FIG. 9 is a schematic diagram of a dense elevation map construction effect according to the present invention; and

FIG. 10 is another schematic diagram of a dense elevation map construction effect according to the present invention.

### DESCRIPTION OF THE EMBODIMENTS

In order to further clarify the purposes, technical solutions, and advantages of the present invention, the following will provide a detailed description of the present invention in combination with the embodiments with reference to the drawings. It should be understood that the specific embodiments described herein are only intended to describe the present invention, instead of limiting the present invention.

On the contrary, the present invention encompasses any substitution, modification, equivalent method, and solution defined by the claims within the essence and scope of the present invention. Further, in order to provide the public with a better understanding of the present invention, specific details are described in detail in the following description of the present invention. For those skilled in the art, the present invention can be fully understood without the description of these detailed parts.

Unless otherwise defined, all technical and scientific terms used herein have the same meanings as those commonly understood by those skilled in the art to which the present invention belongs. The terms used herein are only for the purpose of describing the specific embodiments, instead of limiting the present invention. The term “or/and” used herein includes any and all combinations of one or more related listed items.

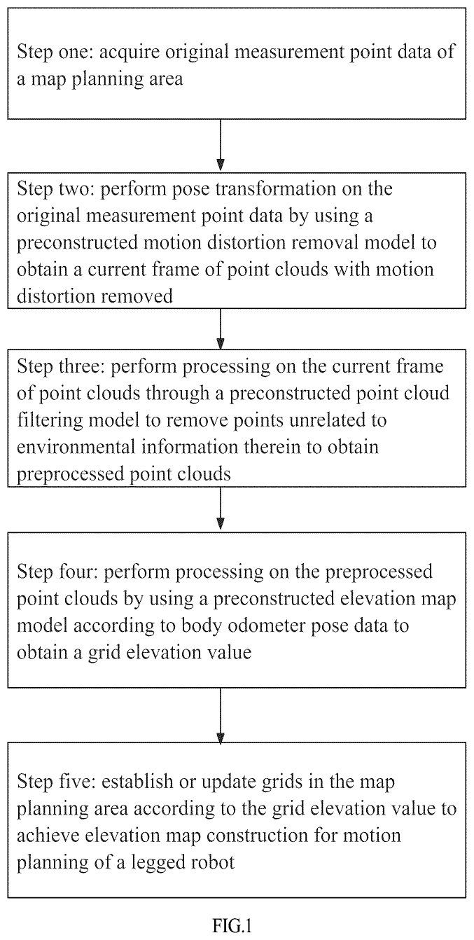

As shown in FIG. 1, it shows a first specific embodiment of an elevation map construction method for motion planning of a legged robot according to the present invention.

The elevation map construction method for the motion planning of the legged robot includes the following steps:
step one: acquiring original measurement point data of a map planning area;
step two: performing pose transformation on the original measurement point data by using a preconstructed motion distortion removal model to obtain a current frame of point clouds with motion distortion removed;
step three: performing processing on the current frame of point clouds through a preconstructed point cloud filtering model to remove points unrelated to environmental information therein to obtain preprocessed point clouds, where
the points unrelated to the environmental information include a body point cloud or/and a leg point cloud or/and a noise point cloud;
step four: performing processing on the preprocessed point clouds by using a preconstructed elevation map model according to body odometer and/or visual odometer and/or laser odometer pose data to obtain a grid elevation value; and
step five: establishing or updating grids in the map planning area according to the grid elevation value to achieve elevation map construction for the motion planning of the legged robot.

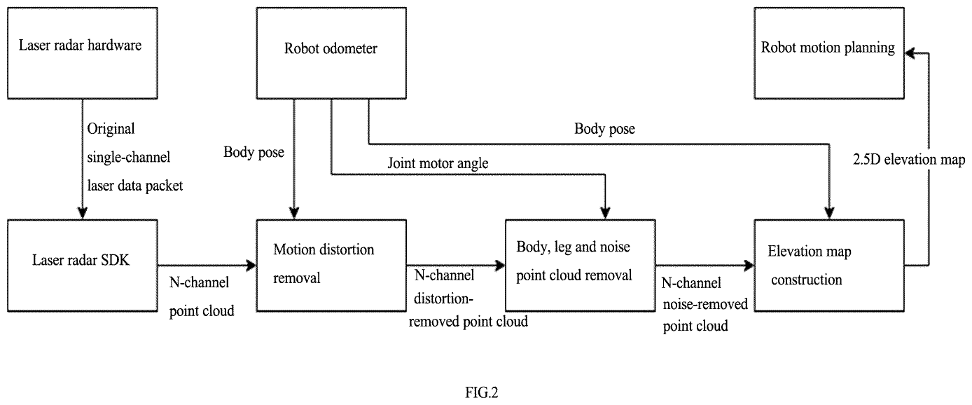

As shown in FIG. 2, it shows a second specific embodiment of the elevation map construction method for the motion planning of the legged robot according to the present invention.

The elevation map construction method for the motion planning of the legged robot includes the following steps:
S1: acquiring a measurement point p^{s} in a sensor coordinate system by using a laser radar, and transforming the measurement point from the sensor coordinate system to a world coordinate system by using a body odometer pose estimate

$$( {R}_{b}^{w} , {t}_{b}^{w} )$$

and a pose transformation

$$( {R}_{s}^{b} , {t}_{s}^{b} )$$

obtained through calibration from a body coordinate system to the sensor coordinate system:

$${p}^{w} = {R}_{b}^{w} ( {R}_{s}^{b} {p}^{s} + {t}_{s}^{b} ) + {t}_{b}^{w}$$

S2: mapping the measurement point from the world coordinate system to a corresponding grid thereof in an elevation map, where a corresponding elevation value thereof is a z-axis component of a measurement point

$${p}^{w} = ( {p}_{x}^{w} , {p}_{y}^{w} , {p}_{z}^{w} ) ,$$

i.e., all elevation measurement value of a current grid, and the elevation measurement value satisfies a Gaussian distribution

$$\tilde{h} \sim N ( {μ}_{\tilde{h}} , {σ}_{\tilde{h}}^{2} ) ;$$

and defining a projection matrix Mₚ=[0,0,1] to obtain a current elevation measurement value:

$$\tilde{h} = {P}_{z}^{w} = {M}_{p} {p}^{w} = {M}_{p} [ {R}_{b}^{w} ( {R}_{s}^{b} {p}^{s} + {t}_{s}^{b} ) + {t}_{b}^{w} ]$$

S3: computing a variance of the current elevation measurement value from covariance propagation:

$${σ}_{\tilde{h}}^{2} = {J}_{p} {\sum }_{p} {J}_{p}^{T} + {J}_{R} {\sum }_{R} {J}_{R}^{T} + {J}_{t} {\sum }_{t} {J}_{t}^{T}$$

where Jₚ, J_{R}, and Jₜ are Jacobian matrices of the elevation measurement value h with respect to p^{s},

$${R}_{b}^{w} , and {t}_{b}^{w} ;$$

Σₚ is a covariance matrix of the measurement point in the sensor coordinate system, and a magnitude thereof depends on a sensor measurement noise model; Σ_{R} is a covariance matrix of a robot odometer rotation; Σₜ is a covariance matrix of a robot odometer translation;
S4: in a case that elevation estimates of grids satisfy a Gaussian distribution

$$\tilde{h} \sim N ( {μ}_{\tilde{h}} , {σ}_{\tilde{h}}^{2} ) ,$$

fusing the current elevation measurement into an elevation estimate of a current grid by computing a normalized product of two Gaussian distributions to obtain an updated elevation estimate:

$${μ}_{\hat{h}} = \frac{{σ}_{\hat{h}}^{2} {μ}_{\tilde{h}} + {σ}_{\tilde{h}}^{2} {μ}_{\hat{h}}}{{σ}_{\hat{h}}^{2} + {σ}_{\tilde{h}}^{2}}$$

$${σ}_{\hat{h}}^{2} = \frac{{σ}_{\hat{h}}^{2} {σ}_{\tilde{h}}^{2}}{{σ}_{\hat{h}}^{2} + {σ}_{\tilde{h}}^{2}} .$$

The elevation map construction method for the motion planning of the legged robot provided in the present invention is based on a dual-axis three-dimensional laser radar, performs point cloud preprocessing steps on sparse point clouds obtained thereby, such as motion distortion removal, leg point cloud removal, and trailing noise point cloud removal, and can further use the processed point cloud and odometer data of the legged robot to construct a robot-centered dense elevation map for the motion planning of the legged robot.

The elevation map construction method for the motion planning of the legged robot provided in the present invention has the advantages of small computational overhead and memory occupation and high computational efficiency, and can achieve real-time high-efficiency environmental elevation map construction on an embedded platform.

Specific embodiment of mapping to obtain a two-dimensional array index to which the corresponding grid belongs in the present invention:

Mapping p^{w} from the world coordinate system to obtain a two-dimensional array index

$$( {I}_{x}^{a} , {I}_{y}^{a} )$$

to which the corresponding grid thereof in the elevation map belongs includes the following steps:
step one: letting a point in the world coordinate system be

$${p}^{w} = [ {p}_{x}^{w} , {p}_{y}^{w} , {p}_{z}^{w} ] ,$$

respectively dividing x and y components thereof by a map resolution r, and performing rounding-down to obtain a 2D integer index of the corresponding grid of the measurement point in the world coordinate system:

$$\{ \begin{matrix}{I}_{x}^{w} = ⌊ {p}_{x}^{w} / r ⌋ \\ {I}_{y}^{w} = ⌊ {p}_{y}^{w} / r ⌋\end{matrix}$$

step two: letting a 2D integer index of an origin of a current map coordinate system in the world coordinate system be

$$[ {I}_{{m}_{x}}^{w} , {I}_{{m}_{y}}^{w} ] ,$$

and computing a 2D integer index of a corresponding grid of the measurement point in a map coordinate system:

$$\{ \begin{matrix}{I}_{x}^{m} = {I}_{x}^{w} - {I}_{{m}_{x}}^{w} \\ {I}_{y}^{m} = {I}_{y}^{w} - {I}_{{m}_{y}}^{w}\end{matrix}$$

step three: letting the elevation map be a grid map with a size of N×N, and determining whether the measurement point is within an elevation map range by determining whether the following two conditions are simultaneously satisfied:

$$\{ \begin{matrix}{I}_{x}^{m} = ∈ [ 0 , N ) \\ {I}_{y}^{m} = ∈ [ 0 , N )\end{matrix}$$

step four: in a case that the measurement point simultaneously satisfies the two conditions, i.e., the measurement point is within the map range, performing a modulo operation on the 2D integer index in the world coordinate system to a map size N, thus obtaining a two-dimensional array index through mapping:

$$\{ \begin{matrix}{I}_{x}^{a} = {I}_{x}^{w} {mod}^{N} \\ {I}_{y}^{a} = {I}_{y}^{w} {mod}^{N}\end{matrix}$$

step five: changing the index mapping step to a binary form with high computational efficiency, i.e., changing the modulo operation “mod” to binary bitwise and operation “&”, by setting the length and width of the elevation map to exponents of 2 with the same magnitude, i.e., N=2ⁿ:

$$\{ \begin{matrix}{I}_{x}^{a} = {I}_{x}^{w} \& ( {2}^{n} - 1 ) \\ {I}_{y}^{a} = {I}_{y}^{w} \& ( {2}^{n} - 1 )\end{matrix} .$$

Specific embodiment of motion distortion removal in the present application:

Performing motion distortion removal on the measurement point p^{s} in the sensor coordinate system includes the following steps:
A1: putting a current frame of point clouds with a timestamp into a point cloud queue, and putting a robot odometer pose with a timestamp into an odometer queue; in a case that a current point cloud queue is not empty, traversing the odometer queue from front to back, and maintaining a queue first frame timestamp of the odometer queue aligned with a point cloud start point timestamp;
A2: for the current frame of point clouds, letting a timestamp of a start point be tₛ, letting a timestamp of an end point be tₑ, and using the timestamp of the end point as a timestamp of the current frame of point clouds, denoted as t_{c}=tₑ;
A3: traversing the odometer queue from front to back, and finding out adjacent two frames of odometer poses just before and after a point cloud timestamp, denoted as

$${T}_{b}^{w} ( {t}_{k} ) and {T}_{b}^{w} ( {t}_{k + 1} ) ,$$

satisfying tₖ≥t_{c}<tₖ₊₁; then computing a robot odometer pose at the point cloud timestamp through a linear interpolation method:

$${T}_{b}^{w} ( {t}_{c} ) = \frac{{t}_{k + 1} - {t}_{c}}{{t}_{k + 1} - {t}_{k}} {T}_{b}^{w} ( {t}_{k} ) + ( 1 - \frac{{t}_{k + 1} - {t}_{c}}{{t}_{k + 1} - {t}_{k}} ) {T}_{b}^{w} ( {t}_{k + 1} )$$

A4: traversing each point in the point cloud queue backwards from the start point according to the timestamp, where a currently traversed original measurement point is

$${p}_{a}^{s}$$

and a timestamp thereof is tₚ, and performing linear interpolation on the adjacent two frames of odometer poses at the time to obtain a robot odometer pose at a time corresponding to the measurement point, denoted as

$${T}_{b}^{w} ( {t}_{p} ) ;$$

A5: transforming the original measurement point

$${p}_{a}^{s}$$

from the sensor coordinate system at a time tₚ to a sensor coordinate system at a unified time corresponding to the timestamp t_{c} of the current frame of point clouds through pose transformation:

$${p}_{b}^{s} = {[ {T}_{b}^{w} ( {t}_{c} ) {T}_{s}^{b} ]}^{- 1} {T}_{b}^{w} ( {t}_{p} ) {T}_{s}^{b} {p}_{a}^{s}$$

thus obtaining a current frame of point clouds

$${P}_{b}^{s}$$

with motion distortion removed.

Specific embodiment of trailing point cloud removal in the present invention:
performing trailing point cloud removal on the current frame or point clouds

$${P}_{b}^{s}$$

includes the following steps:
B1: computing polar coordinates of a point p^{s} in the point clouds in the sensor coordinate system:

$$\{ \begin{matrix}{s}_{r} = \sqrt{{( {p}_{x}^{s} )}^{2} + {( {p}_{y}^{s} )}^{2} + {( {p}_{z}^{s} )}^{2}} \\ {s}_{p} = arc cos ( {p}_{z}^{s} / {s}_{r} ) \\ {s}_{a} = arc tan ( {p}_{y}^{s} / {p}_{x}^{s} )\end{matrix}$$

where sᵣ is a length of a vector p^{s}, sₚ is an included angle between the vector p^{s} and a positive direction of a Z-axis of the sensor coordinate system, and s_{α} is an included angle between a projection vector of the vector p^{s} in an XY plane of the sensor coordinate system and a positive direction of an X-axis;
B2: in a polar coordinate system, projecting all points onto a spherical surface with sᵣ=1, and then selecting a specific rectangular area of the spherical surface to remove a trailing point cloud projected thereto:

$$\{ \begin{matrix}{s}_{p} ∈ [ {s}_{{p}_{min}} , {s}_{{p}_{max}} ] \\ {s}_{a} ∈ [ {s}_{{a}_{min}} , {s}_{{a}_{min}} ]\end{matrix} .$$

Specific embodiment of leg point cloud removal in the present invention:
Performing leg point cloud removal on the current frame of point clouds

$${P}_{b}^{s}$$

includes the following steps:
C1: projecting a position Aₒ of a knee joint in the sensor coordinate system and a position Bₒ of a foot end in the sensor coordinate system onto a spherical surface with a radius of 1 in the sensor coordinate system; letting two points after projection be respectively A and B, then obtaining:

$$SA = \frac{{SA}_{o}}{\vert {SA}_{o} \vert}$$

$$SB = \frac{{SB}_{o}}{\vert {SB}_{o} \vert}$$

constructing a set of standard orthogonal bases from vectors SA and SB:

$$\{ \begin{matrix}{b}_{x} = S A \\ {b}_{z} = S N = S A \times S B \\ {b}_{y} = S F = {b}_{z} \times S A\end{matrix}$$

C2: letting a foot of a perpendicular of a point P projected onto an XY plane of the standard orthogonal bases be H=[hₓ, h_{y}, h_{z}]^{T}, then the foot of the perpendicular being:

$$\{ \begin{matrix}{h}_{x} = SP \cdot SA \\ {h}_{y} = SP \cdot SF \\ {h}_{z} = SP \cdot SN\end{matrix}$$

under the standard orthogonal bases, computing spherical coordinates (1, θ, φ) of a laser point P:

$$\{ \begin{matrix}θ = ∠ NSP = arccos ( SP \cdot SN ) \\ ϕ = ∠ ASH = arctan ( {h}_{y} / {h}_{x} )\end{matrix}$$

C3: assuming that a projection of a leg link is a rectangle on a normalized spherical surface, determining whether the point P is within the rectangle range through the following formula:

$$\{ \begin{matrix}0.5 π - θ ∈ ( - 0.5 b , 0.5 b ) \\ ϕ ∈ ( 0 , l )\end{matrix}$$

where b is the maximum width of the leg link after projection and/is the maximum length of the leg link after projection; in a case that the point P is within the rectangle range, removing the point P.

As shown in FIG. 2, it shows a preferred specific embodiment of the method according to the present invention.

To accurately describe the present invention, coordinate systems and commonly used symbols are defined first.

Firstly, the present invention mainly includes four reference coordinate systems, all of which are right-handed coordinate systems, namely an inertial world coordinate system {W}, a robot body coordinate system {B}, a sensor coordinate system {S}, and a map coordinate system {M}, as shown in FIG. 3.

The world coordinate system {W} remains stationary relative to the terrain environment, with its x y coordinate axis plane aligned with a horizontal plane.

The body coordinate system {B} is a fixed coordinate system that is fixedly connected to a robot body, and is usually a center position of robot's rotation.

The sensor coordinate system is a reference coordinate system for a sensor measurement value.

Orientations of the x, y and z coordinate axes of the map coordinate system {M} are consistent with those of the world coordinate system, its xy plane coincides with that of the world coordinate system, and x and y of an origin of the coordinate system move with the body coordinate system, so that a center grid of the map always coincides with the body coordinate system.

Since a timestamp of each point collected by the sensor is different, a pose of the sensor coordinate system at a timestamp corresponding to the measurement point in the world coordinate system is also different. Therefore, an original collected frame of point clouds contain distortion caused by sensor motion, known as motion distortion.

Performing motion distortion removing include the following steps:
Step one: putting a current frame of point clouds with a timestamp into a point cloud queue cloudQueue, and putting a robot odometer pose with a timestamp into an odometer queue odomQueue;
step two: in a case that a current point cloud queue is not empty, traversing the odometer queue from front to back, and maintaining a queue first frame timestamp of the odometer queue aligned with a point cloud start point timestamp, i.e., in a case that the queue first frame timestamp of the odometer queue is smaller than the point cloud start point timestamp, removing it out of the queue;
step three: for the current frame of point clouds, letting a timestamp of a first point (i.e., a start point) according to a time sequence be tₛ, letting a timestamp of a last point (i.e., an end point) be tₑ, and using the timestamp of the end point as a timestamp of the current frame of point clouds, denoted as t_{c}=tₑ;
step four: traversing the odometer queue from front to back, and finding out adjacent two frames of odometer poses just before and after a point cloud timestamp, denoted as

$${T}_{b}^{w} ( {t}_{k} ) and {T}_{b}^{w} ( {t}_{k + 1} ) ,$$

satisfying tₖ≤t_{c}<tₖ₊₁; then computing a robot odometer pose at the point cloud timestamp through a linear interpolation method, denoted as:

$${T}_{b}^{w} ( {t}_{c} ) = \frac{{t}_{k + 1} - {t}_{c}}{{t}_{k + 1} - {t}_{k}} {T}_{b}^{w} ( {t}_{k} ) + ( 1 - \frac{{t}_{k + 1} - {t}_{c}}{{t}_{k + 1} - {t}_{k}} ) {T}_{b}^{w} ( {t}_{k + 1} )$$

step five: traversing each point in the point cloud queue backwards from the start point according to the timestamp, letting a currently traversed original measurement point be

$${p}_{a}^{s}$$

and a timestamp thereof be tₚ, and similarly performing linear interpolation to obtain a robot odometer pose at a time corresponding to the measurement point, denoted as

$${T}_{b}^{w} ( {t}_{p} ) ;$$

step six: transforming the currently traversed original measurement point

$${p}_{a}^{s}$$

from the sensor coordinate system at a time tₚ to a sensor coordinate system at a unified time t_{c} through pose transformation, thus achieving motion distortion removal:

$${p}_{b}^{s} = {[ {T}_{b}^{w} ( {t}_{c} ) {T}_{s}^{b} ]}^{- 1} {T}_{b}^{w} ( {t}_{p} ) {T}_{s}^{b} {p}_{a}^{s} .$$

A method for performing trailing point cloud filtering and leg point cloud filtering in a spherical coordinate system includes the following steps:

For the current frame of point clouds

$${P}_{b}^{s}$$

with motion distortion removed, points unrelated to environmental information therein further need to be removed, mainly including a body point cloud, a leg point cloud, and a noise point cloud.

For a point

$${p}^{s} = {[ {p}_{x}^{s} , {p}_{y}^{s} , {p}_{z}^{s} ]}^{T} ∈ {P}_{b}^{s}$$

with motion distortion removed, firstly polar coordinates thereof in the sensor coordinate system {S} are computed:

$$\{ \begin{matrix}{s}_{r} = \sqrt{{( {p}_{x}^{r} )}^{2} + {( {p}_{y}^{r} )}^{2} + {( {p}_{z}^{s} )}^{2}} \\ {s}_{p} = arccos ( {p}_{z}^{s} / {s}_{r} ) \\ {s}_{a} = arctan ( {p}_{y}^{s} / {p}_{x}^{s} )\end{matrix}$$

where sᵣ is a length of a vector p^{s}, sₚ is an included angle between the vector p^{s} and a positive direction of a Z-axis of the sensor coordinate system, and s_{α} is an included angle between a projection vector of the vector p^{s} in an XY plane of the sensor coordinate system and a positive direction of an X-axis.

In a polar coordinate system, all points may be projected onto a spherical surface with sᵣ=1, and then a specific rectangular area of the spherical surface is selected to remove a trailing point cloud projected thereto, so that the trailing point cloud can be removed very well. An example is as follows:

$$\{ \begin{matrix}{s}_{p} ∈ [ {s}_{{p}_{min}} , {s}_{{p}_{max}} ] \\ {s}_{a} ∈ [ {s}_{{a}_{min}} , {s}_{{a}_{min}} ]\end{matrix}$$

In order to remove leg point clouds of a four-legged robot, firstly a position of each joint in the body coordinate system is computed from angles of motor joints based on based on the forward kinematics of the robot, and then the position is transformed to the sensor coordinate system.

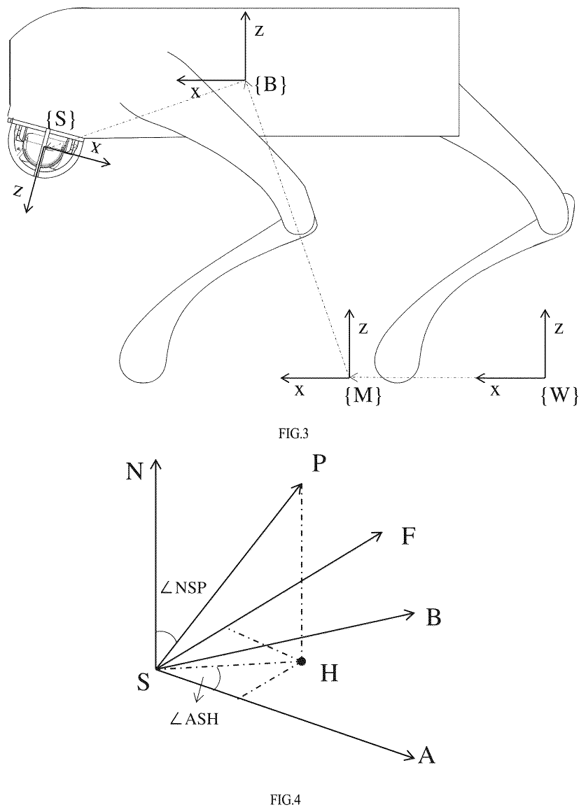

As shown in FIG. 4, taking a left front lower leg joint as an example, positions of a knee joint and a foot end thereof in the sensor coordinate system are let to be respectively A₀ and B₀, and firstly the positions are projected onto a spherical surface with a radius of 1 in the sensor coordinate system {S}. Two points after projection are let to be respectively A and B, then obtaining:

$$SA = \frac{{SA}_{o}}{\vert {SA}_{o} \vert}$$

$$SB = \frac{{SB}_{o}}{\vert {SB}_{o} \vert}$$

A set of standard orthogonal bases may be constructed from vectors SA and SB:

$$\{ \begin{matrix}{b}_{x} = S A \\ {b}_{Z} = S N = S A \times S B \\ {b}_{y} = S F = {b}_{z} \times S A\end{matrix}$$

A foot of a perpendicular of a point P projected onto an XY plane of the standard orthogonal bases is let to be H=[hₓ, h_{y}, h_{z}]^{T}, and then the foot of the perpendicular is:

$$\{ \begin{matrix}{h}_{x} = SP \cdot SA \\ {h}_{y} = SP \cdot SF \\ {h}_{z} = SP \cdot SN\end{matrix}$$

Under the standard orthogonal bases, spherical coordinates (1, θ, φ) of a laser point P may be computed.

$$\{ \begin{matrix}θ = ∠ NSP = arccos ( SP \cdot SN ) \\ ϕ = ∠ ASH = arctan ( {h}_{y} / {h}_{x} )\end{matrix}$$

It is assumed that a projection of a lower leg link approximates a rectangle on a normalized spherical surface, and then A and B are central axes of the rectangle. The maximum width of the lower leg link after projection is let to be b and the maximum length of the lower leg link is let to be l, and then whether the point P is within the rectangle range may be determined through the following formula:

$$\{ \begin{matrix}0.5 π - θ ∈ ( - 0.5 b , 0.5 b ) \\ ϕ ∈ ( 0 , l )\end{matrix}$$

In a case that the measurement point is within the rectangle, it is considered that the measurement point is a leg point, and the measurement point is removed from the point cloud.

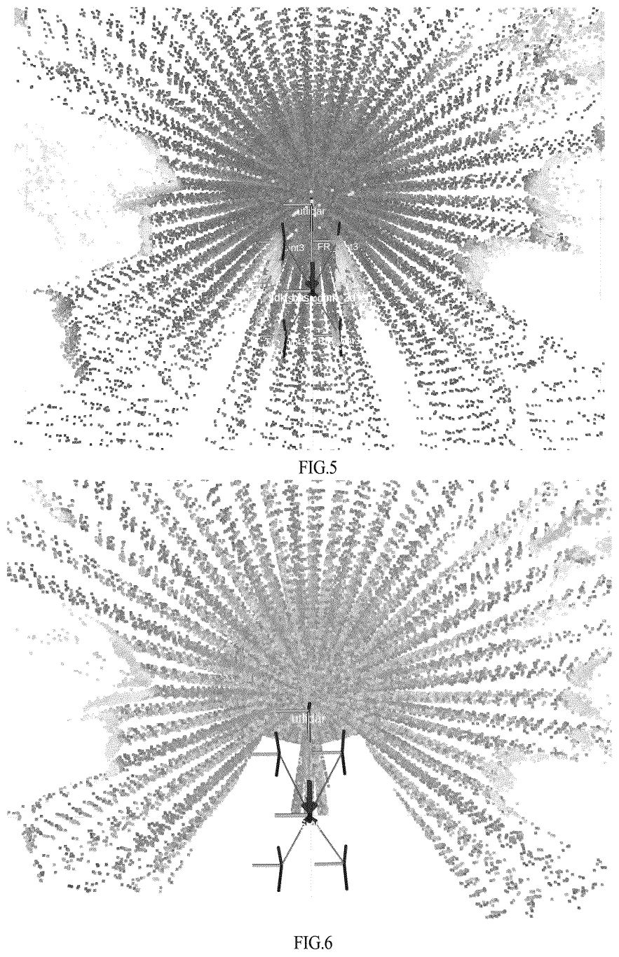

Effects before and after noise point cloud and leg point cloud removal are as shown in FIG. 5 and FIG. 6.

An elevation map model based on a circular buffer includes the following contents:

Commonly used map model include various forms such as 2D grid maps, 3D grid maps, point cloud maps, octree maps, and topological maps. Octree maps have the advantage of small memory occupation, but have the disadvantage of low access efficiency of elements, whose number is a logarithm of the number of map nodes. On the contrary, grid maps have the disadvantage of large memory occupation, but have the advantage of high access efficiency because element access time is a constant value. Considering the balance between storage efficiency and indexing efficiency of maps, a 2D grid map model is selected to represent environmental information, and a high-efficiency elevation map construction method based on a circular buffer is constructed.

For computers, regardless of the type of map model, its storage method is ultimately linear storage. To construct a 2.5D elevation map, the first step is to define the data structure for storing and accessing map elements in the computer. Specifically, the data structure should have the following functions:
given a three-dimensional point in space, obtaining its corresponding grid index in a elevation map through computation, and further obtaining its storage index in a computer memory;
moving the entire map in a certain direction by a voxel distance;
determining whether a point is within a voxel map.

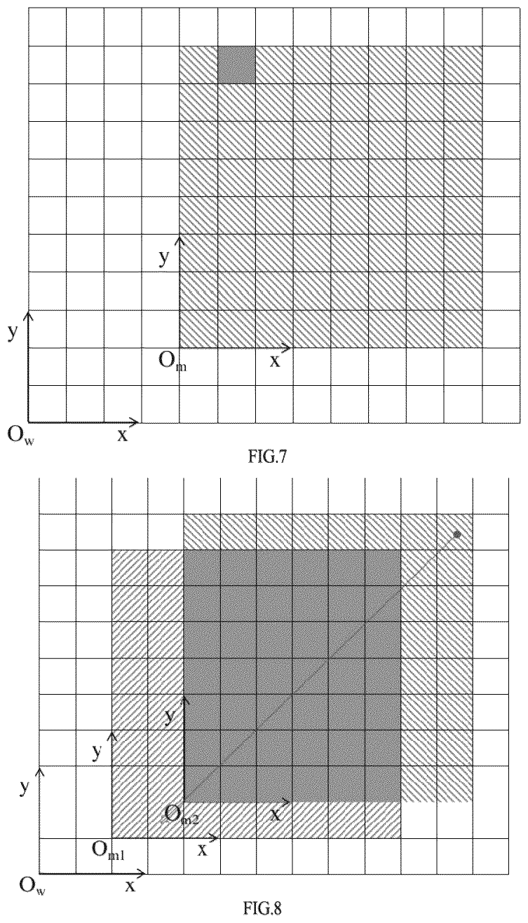

As shown in FIG. 7, a geometric structure of the 2.5D elevation map is defined as follows: —the map resolution is r, that is, the side length of a square grid is r; —the elevation map is a square area composed of N×N grids; —the coordinate axis direction of the map coordinate system is consistent with that of the world coordinate system, and it only moves in x and y directions; —the origin of the map coordinate system is a grid with the smallest x and y coordinates of all grids of the current elevation map, denoted as Oₘ.

Determining whether a point in the world coordinate system is within the map range, and mapping the point to a corresponding 2D grid in the map and a one-dimensional array index include the following steps:
letting a in the world coordinate system be

$${p}^{w} = [ {p}_{x}^{w} , {p}_{y}^{w} , {p}_{z}^{w} ] ,$$

respectively dividing x and y components thereof by the map resolution r, and performing rounding-down to obtain a 2D integer index of the point in the world coordinate system:

$$\{ \begin{matrix}{I}_{x}^{w} = floor ⌊ {p}_{x}^{w} / r ⌋ \\ {I}_{y}^{w} = floor ⌊ {p}_{y}^{w} / r ⌋\end{matrix} \qquad ( 10 )$$

letting a 2D integer index of an origin of the current map coordinate system in the world coordinate system be

$$[ {I}_{{m}_{x}}^{w} , {I}_{{m}_{y}}^{w} ] ,$$

and computing a 2D integer index of the measurement point in the map coordinate system:

$$\{ \begin{matrix}{I}_{x}^{m} = {I}_{x}^{w} - {I}_{{m}_{x}}^{w} \\ {I}_{y}^{m} = {I}_{y}^{w} - {I}_{{m}_{y}}^{w}\end{matrix} \qquad ( 11 )$$

determining whether the measurement point is within a map range by determining whether the following two conditions are simultaneously satisfied:

$$\{ \begin{matrix}{I}_{x}^{m} ∈ [ 0 , N ) \\ {I}_{y}^{m} ∈ [ 0 , N )\end{matrix} \qquad ( 12 )$$

in a case that the measurement point simultaneously satisfies the two conditions, i.e., the measurement point is within the map range, performing a modulo operation on the 2D integer index in the world coordinate system to a map size N, thus obtaining a two-dimensional array index through mapping:

$$\{ \begin{matrix}{I}_{x}^{a} = {I}_{x}^{w} {mod}^{N} \\ {I}_{y}^{a} = {I}_{y}^{w} {mod}^{N}\end{matrix} \qquad ( 13 )$$

changing the index mapping step to a binary form with high computational efficiency, i.e., changing the modulo operation “mod” to binary bitwise and operation “&”, by setting the length and width of the elevation map to exponents of 2 with the same magnitude, i.e., N=2ⁿ:

$$\{ \begin{matrix}{I}_{x}^{a} = {I}_{x}^{w} \& ( {2}^{n} - 1 ) \\ {I}_{y}^{a} = {I}_{y}^{w} \& ( {2}^{n} - 1 )\end{matrix} \qquad ( 14 )$$

finally, uniquely mapping the two-dimensional array index to a one-dimensional array index I_{α}, which corresponds to a storage address of the grid in the computer:

$${I}_{a} = {I}_{x}^{m} \times N + {I}_{y}^{m} , {I}_{a} ∈ [ 0 , {N}^{2} - 1 ]$$

Here, taking the elevation map described above as an example, the size of the map is N=2³=8. The integer index of dark grids on the map is

$$( {I}_{x}^{w} = 5 , {I}_{y}^{w} = 9 ,$$

the integer index in the map coordinate system is

$$( {I}_{x}^{m} = 1 , {I}_{y}^{m} = 7 ) ,$$

the two-dimensional array index is

$$( {I}_{x}^{a} = 5 , {I}_{x}^{a} = 1 ,$$

and the one-dimensional array index is I_{α}=5×8+1=41.

In addition, when the robot moves, it is necessary to control the movement of the map coordinate system so that the origin of the robot coordinate system always remains vertically above the center of the map. As shown, when the map coordinate system is moved from Oₘ₁ to Oₘ₂, the grid area (blue grid) of the overlapping part before and after the movement has unchanged two-dimensional array index and one-dimensional array index stored therein, so there is no need to move it in the stored array, thus saving a lot of computing resources; the indices of a newly added grid (diagonal area at an upper right corner) and a discarded grid (diagonal area at a lower left corner) in the two-dimensional array correspond exactly one to one, so it is only necessary to store the value of the newly added grid at an address of the discarded grid. For example, as indicated by an arrow in FIG. 8, a two-dimensional array index of a grid at a topmost right corner in the map Oₘ₂ after movement is (3,1), which corresponds exactly to the second grid in a bottommost row of the map Oₘ₁ before movement.

Construction of the elevation map includes the following contents:

For the point cloud after the preprocessing step, each point therein is used as a measurement to update a corresponding grid thereof in the elevation map. For each grid in the elevation map, an estimated elevation value of the grid is represented by using a Gaussian distribution model:

$$\hat{h} ∼ N ( {μ}_{\hat{h}} , {σ}_{\hat{h}}^{2} )$$

where μ_{ĥ} and

$${σ}_{\hat{h}}^{2}$$

are respectively a mean value and a variance of a Gaussian distribution.

A measurement point in the sensor coordinate system is let to be p^{s}, and the measurement point is transformed from the sensor coordinate system to the world coordinate system by using a body odometer pose estimate

$$( {R}_{b}^{w} , {t}_{b}^{w} )$$

and a pose transformation

$$( {R}_{s}^{b} , {t}_{s}^{b} )$$

obtained through calibration from the body coordinate system to the sensor coordinate system:

$${p}^{w} = {R}_{b}^{w} ( {R}_{s}^{b} {p}^{s} + {t}_{s}^{b} ) + {t}_{b}^{w}$$

From formulas (10) to (14), the measurement point may be mapped from the world coordinate system to obtain a corresponding two-dimensional array index

$$( {I}_{x}^{a} , {I}_{y}^{a} )$$

thereof, where a corresponding elevation value thereof is a z-axis component of a measurement point

$${p}^{w} = ( {p}_{x}^{w} , {p}_{y}^{w} , {p}_{z}^{w} ) ,$$

i.e., an elevation measurement value of a current grid. A projection matrix Mₚ=[0,0,1] is defined to obtain a current elevation measurement value:

$$\tilde{h} = {p}_{z}^{w} = {M}_{p} {p}^{w} = {M}_{p} [ {R}_{b}^{w} ( {R}_{s}^{b} {p}^{s} + {t}_{s}^{b} ) + {t}_{b}^{w} ]$$

Since a pose transformation from the sensor coordinate system to the robot coordinate system is a fixed value obtained through calibration, it is not necessary to consider its variance. Assuming that the measurement point p^{s} in the sensor coordinate system also satisfies a Gaussian distribution, variance propagation of an elevation estimate mainly depends on a variance of a sensor measurement p^{s}, a variance of a robot odometer rotation

$${R}_{b}^{w} ,$$

and a variance of a robot odometer translation

$${t}_{b}^{w} .$$

Derivation may be performed to obtain Jacobian matrices of the elevation measurement value \tilde{h} with respect to p^{s},

$${R}_{b}^{w} , and {t}_{b}^{w} :$$

$${J}_{p} = \frac{\partial \tilde{h}}{\partial {p}^{s}}$$

$${J}_{R} = \frac{\partial \tilde{h}}{\partial {R}_{b}^{w}}$$

$${J}_{t} = \frac{\partial \tilde{h}}{\partial {t}_{b}^{w}}$$

Then, a variance of the current elevation measurement value is computed through covariance propagation:

$${σ}_{\tilde{h}}^{2} = {J}_{p} {\sum }_{p} {J}_{p}^{T} + {J}_{R} {\sum }_{R} {J}_{R}^{T} + {J}_{t} {\sum }_{t} {J}_{t}^{T}$$

where Σₚ is a covariance matrix of the measurement point in the sensor coordinate system, and a magnitude thereof depends on a sensor measurement noise model; Σ_{R} is a covariance matrix of the robot odometer rotation; Σₜ is a covariance matrix of the robot odometer translation.

Thus a Gaussian distribution of the current elevation measurement is obtained:

$$\tilde{h} ∼ N ( {μ}_{\tilde{h}} , {σ}_{\tilde{h}}^{2} )$$

Finally, the current elevation measurement may be fused into the elevation estimate of the current grid by using a Kalman filtering method to obtain an updated elevation estimate:

$${μ}_{\hat{h}} = \frac{{σ}_{\hat{h}}^{2} {μ}_{\tilde{h}} + {σ}_{\tilde{h}}^{2} {μ}_{\hat{h}}}{{σ}_{\hat{h}}^{2} + {σ}_{\tilde{h}}^{2}}$$

$${σ}_{\hat{h}}^{2} = \frac{{σ}_{\hat{h}}^{2} {σ}_{\tilde{h}}^{2}}{{σ}_{\hat{h}}^{2} + {σ}_{\tilde{h}}^{2}}$$

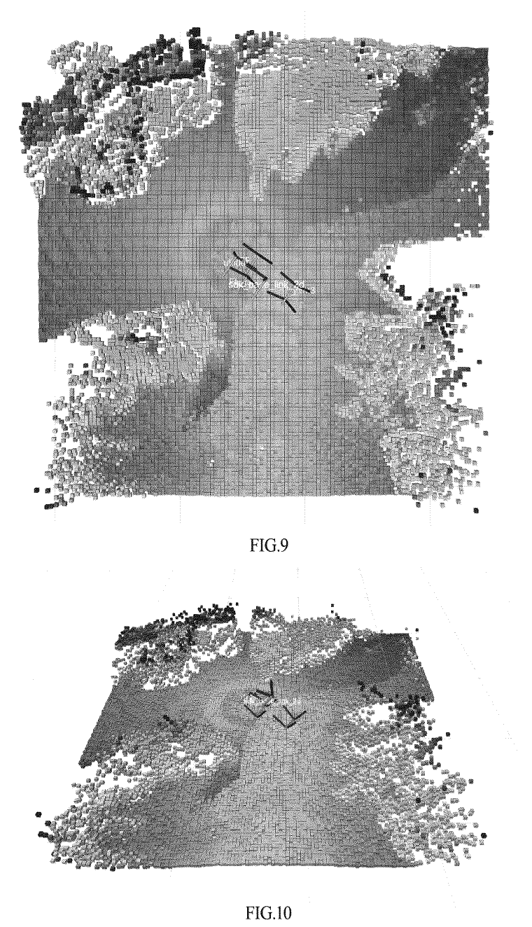

Effects of the elevation map constructed in the present invention are as shown in FIG. 9 and FIG. 10.

Device embodiment applying the method in the present invention:

A computer device includes:
one or more processors; and
a storage device, configured to store one or more programs, where
the one or more programs, when executed by the one or more processors, causes the one or more processors to implement the elevation map construction method for the motion planning of the legged robot described above.

Computer medium embodiment applying the method in the present invention:

A computer-readable storage medium has a computer program stored therein, where the program, when executed by a processor, implements the elevation map construction method for the motion planning of the legged robot described above.

Finally, it should be noted that the above embodiments are only intended to describe rother than limit the technical solution of the present invention. Although the present invention has been described in detail with reference to the above embodiments, those skilled in the art should understand that modifications or equivalent replacements may still be made to the specific embodiments of the present invention, and any modifications or equivalent replacements that do not depart from the spirit and scope of the present invention should fall within the scope of protection of the claims of the present invention.

1. An elevation map construction method for motion planning of a legged robot,
comprising the following steps:
step one: acquiring original measurement point data of a map planning area;
step two: performing pose transformation on the original measurement point data by using a preconstructed motion distortion removal model to obtain a current frame of point clouds with motion distortion removed;
step three: performing processing on the current frame of point clouds through a preconstructed point cloud filtering model to remove points unrelated to environmental information therein to obtain preprocessed point clouds, wherein
the points unrelated to the environmental information comprise a body point cloud or/and a leg point cloud or/and a noise point cloud;
step four: performing processing on the preprocessed point clouds by using a preconstructed elevation map model according to body odometer and/or visual odometer and/or laser odometer pose data to obtain a grid elevation value; and
step five: establishing or updating grids in the map planning area according to the grid elevation value to achieve elevation map construction for the motion planning of the legged robot.

2. The elevation map construction method for the motion planning of the legged robot according to claim 1, wherein
in step two, a method for the motion distortion removal model to perform motion distortion removal on the original measurement point data comprises the following steps:
step 1: putting the current frame of point clouds with a timestamp into a point cloud queue cloudQueue, and putting a robot odometer pose with a timestamp into an odometer queue odomQueue;
step 2: in a case that a current point cloud queue is not empty, traversing the odometer queue from front to back, and maintaining a queue first frame timestamp of the odometer queue aligned with a point cloud start point timestamp, i.e., in a case that the queue first frame timestamp of the odometer queue is smaller than the point cloud start point timestamp, removing the queue first frame timestamp out of the queue;
step 3: performing ordering on the current frame of point clouds according to a time sequence, wherein a timestamp of a first point, i.e., a start point, is denoted as tₑ, and a timestamp of a last point, i.e., an end point, is denoted as tₑ;
using the timestamp of the end point as a timestamp of the current frame of point clouds, denoted as t_{c}=tₑ;
step 4: traversing the odometer queue from front to back, and finding out adjacent two frames of odometer poses just before and after the point cloud timestamp, wherein the adjacent two frames of odometer poses are respectively
$${T}_{b}^{w} ( {t}_{k} ) and {T}_{b}^{w} ( {t}_{k + 1} ) ,$$
satisfying tₖ≤t_{c}<tₖ₊₁;
then computing a robot odometer pose at the point cloud timestamp by using a linear interpolation method, wherein an expression thereof is:
$${T}_{b}^{w} ( {t}_{c} ) = \frac{{t}_{k + 1} - {t}_{c}}{{t}_{k + 1} - {t}_{k}} {T}_{b}^{w} ( {t}_{k} ) + ( 1 - \frac{{t}_{k + 1} - {t}_{c}}{{t}_{k + 1} - {t}_{k}} ) {T}_{b}^{w} ( {t}_{k + 1} )$$
step 5: traversing each original measurement point in the point clouds backwards from the start point according to the timestamp; performing linear interpolation to obtain a robot odometer pose at a time corresponding to the original measurement point, denoted as
$${T}_{b}^{w} ( {t}_{p} ) ;$$
and
step 6: transforming a currently traversed original measurement point
$${p}_{a}^{s}$$
from a sensor coordinate system at a time tᵥ to a sensor coordinate system at a unified time t_{c} through pose transformation, so as to achieve motion distortion removal, wherein a computation formula thereof is:
$${p}_{b}^{a} = {[ {T}_{b}^{w} ( {t}_{c} ) {T}_{s}^{b} ]}^{- 1} {T}_{b}^{w} ( {t}_{p} ) {T}_{s}^{b} {p}_{a}^{s} .$$

3. The elevation map construction method for the motion planning of the legged robot according to claim 1, wherein
in step three, a method for the point cloud filtering model to perform processing on the current frame of point clouds
$${p}_{b}^{s}$$
comprises the following steps:
for a point
$${p}^{s} = {[ {p}_{x}^{s} , {p}_{y}^{s} , {p}_{z}^{s} ]}^{T} ∈ {P}_{b}^{s}$$
in the current frame of point clouds with motion distortion removed, computing polar coordinates thereof in a sensor coordinate system {S}:
$$\{ \begin{matrix}{s}_{r} = \sqrt{{( {p}_{x}^{s} )}^{2} + {( {p}_{y}^{s} )}^{2} + {( {p}_{z}^{s} )}^{2}} \\ {s}_{p} = arc cos ( {p}_{z}^{s} / {s}_{r} ) \\ {s}_{a} = arctan ( {p}_{y}^{s} / {p}_{x}^{s} )\end{matrix}$$
where sᵣ is a length of a vector p^{s}, sₚ is an included angle between the vector p^{s} and a positive direction of a Z-axis of the sensor coordinate system, and s_{α} is an included angle between a projection vector of the vector p^{s} in an XY plane of the sensor coordinate system and a positive direction of an X-axis;
in a polar coordinate system, projecting all points onto a spherical surface with sᵣ=1, and then selecting a specific rectangular area of the spherical surface to remove a noise point cloud and a trailing point cloud projected thereto, wherein an expression thereof is:
$$\{ \begin{matrix}{s}_{p} ∈ [ {s}_{{p}_{min}} , {s}_{{p}_{max}} ] \\ {s}_{a} ∈ [ {s}_{{a}_{min}} , {s}_{{a}_{min}} ]\end{matrix}$$
in order to remove point clouds of legs of the legged robot, based on the forward kinematics of the robot, computing a position of each joint in the body coordinate system from angles of motor joints, and then transforming the position into the sensor coordinate system;
letting positions of a knee joint and a foot end in the sensor coordinate system be respectively A₀, and B₀, and firstly projecting the positions onto a spherical surface with a radius of 1 in the sensor coordinate system {S}; letting two points after projection be respectively A and B, then obtaining:
$$SA = \frac{{SA}_{o}}{\vert {SA}_{o} \vert}$$
$$SB = \frac{{SB}_{o}}{\vert {SB}_{o} \vert}$$
constructing a set of standard orthogonal bases from vectors SA and SB:
$$\{ \begin{matrix}{b}_{x} = SA \\ {b}_{z} = SN = SA \times SB \\ {b}_{y} = SF = {b}_{z} \times SA\end{matrix}$$
letting a foot of a perpendicular of a point P projected onto an XY plane of the standard orthogonal bases be H=[hₓ, h_{y}, h_{z}]^{T}, then the foot of the perpendicular being:
$$\{ \begin{matrix}{h}_{x} = SP \cdot SA \\ {h}_{y} = SP \cdot SF \\ {h}_{z} = SP \cdot SN\end{matrix}$$
under the standard orthogonal bases, computing spherical coordinates (1, δ, φ) of a laser point P:
$$\{ \begin{matrix}θ = ∠ NSP = arc cos ( SP \cdot SN ) \\ ϕ = ∠ ASH = arc tan ( {h}_{y} / {h}_{x} )\end{matrix}$$
wherein a projection of a lower leg link approximates a rectangle on a normalized spherical surface, and then A and B are central axes of the rectangle;
letting the maximum width of the lower leg link after projection be b and the maximum length of the lower leg link be l, and then determining whether the point P is within the rectangle range through the following formula:
$$\{ \begin{matrix}0.5 π - θ ∈ ( - 0.5 b , 0.5 b ) \\ ϕ ∈ ( 0 , l )\end{matrix}$$
in a case that the measurement point is within the rectangle, considering that the measurement point is a leg point, and removing the measurement point from the point cloud to achieve leg point cloud removal.

4. The elevation map construction method for the motion planning of the legged robot according to claim 1, wherein
in step four, the elevation map model treats each measurement point of the preprocessed point cloud as a measurement to establish or update the grids in the map planning area, and a method for the elevation map model to perform processing on the preprocessed point clouds comprises:
for each grid in the map planning area, representing an estimated elevation value of the grid by using a Gaussian distribution model:
$$\hat{h} \sim N ( {μ}_{\hat{h}} , {σ}_{\hat{h}}^{2} )$$
where μ_{ĥ} and σ_{ĥ}² are respectively a mean value and a variance of a Gaussian distribution;
for a measurement point p^{s} in the sensor coordinate system, transforming the measurement point from the sensor coordinate system to a world coordinate system by using a body odometer pose estimate
$$( {R}_{b}^{w} , {t}_{b}^{w} )$$
and a pose transformation
$$( {R}_{s}^{b} , {t}_{s}^{b} )$$
obtained through calibration from the body coordinate system to the sensor coordinate system:
$${p}^{w} = {R}_{b}^{w} ( {R}_{s}^{b} {p}^{s} + {t}_{s}^{b} ) + {t}_{b}^{w}$$
determining a formula group by using a map index, and mapping the measurement point from the world coordinate system to obtain a corresponding two-dimensional array index
$$( {I}_{x}^{a} , {I}_{y}^{a} )$$
thereof, wherein a corresponding elevation value thereof is a z-axis component of a measurement point
$${p}^{w} = ( {p}_{x}^{w} , {p}_{y}^{w} , {p}_{z}^{w} ) ,$$
i.e., an elevation measurement value of a current grid;
establishing a projection matrix Mₚ=[0,0,1] to obtain a current elevation measurement value:
$$\tilde{h} = {p}_{z}^{w} = {M}_{p} {p}^{w} = {M}_{p} [ {R}_{b}^{w} ( {R}_{s}^{b} {p}^{s} + {t}_{s}^{b} ) + {t}_{b}^{w} ]$$
wherein a pose transformation from the sensor coordinate system to a robot coordinate system is a fixed value obtained through calibration;
in a case that the measurement point p^{z} in the sensor coordinate system satisfies a Gaussian distribution, variance propagation of an elevation estimate thereof mainly depends on a variance of a sensor measurement p^{z}, a variance of a robot odometer rotation
$${R}_{b}^{w} ,$$
and a variance of a robot odometer translation
$${t}_{b}^{w} ;$$
performing derivation to obtain Jacobian matrices of the elevation measurement value \tilde{h} with respect to p^{z},
$${R}_{b}^{w} , and {t}_{b}^{w} :$$
$${J}_{p} = \frac{\partial \tilde{h}}{\partial {p}^{s}} \\ {J}_{R} = \frac{\partial \tilde{h}}{\partial {R}_{b}^{w}} \\ {J}_{t} = \frac{\partial \tilde{h}}{\partial {t}_{b}^{w}}$$
then, computing a variance of the current elevation measurement value through covariance propagation:
$${σ}_{\tilde{h}}^{2} = {J}_{p} {\sum }_{p} {J}_{p}^{T} + {J}_{R} {\sum }_{R} {J}_{R}^{T} + {J}_{t} {\sum }_{t} {J}_{t}^{T}$$
where Σᵥ is a covariance matrix of the measurement point in the sensor coordinate system, and a magnitude thereof depends on a sensor measurement noise model; Σ_{R} is a covariance matrix of the robot odometer rotation; Σₜ is a covariance matrix of the robot odometer translation;
thus obtaining a Gaussian distribution of the current elevation measurement:
$$\tilde{h} ∼ N ( {μ}_{\tilde{h}} , {σ}_{\tilde{h}}^{2} )$$
fusing the current elevation measurement into the elevation estimate of the current grid by using a Kalman filtering method to obtain an updated grid elevation value:
$${μ}_{\tilde{h}} = \frac{{σ}_{\tilde{h}}^{2} {μ}_{h} + {σ}_{\tilde{h}}^{2} {μ}_{\tilde{h}}}{{σ}_{\tilde{h}}^{2} + {σ}_{\tilde{h}}^{2}} \\ {σ}_{\tilde{h}}^{2} = \frac{{σ}_{\tilde{h}}^{2} + {σ}_{\tilde{h}}^{2}}{{σ}_{\tilde{h}}^{2} + {σ}_{\tilde{h}}^{2}}$$
finally completing the elevation map construction for the motion planning of the legged robot according to the grid elevation value.

5. An elevation map construction method for motion planning of a legged robot,
comprising the following steps:
S1: acquiring a measurement point p^{z} in a sensor coordinate system collected by a laser radar, and transforming the measurement point from the sensor coordinate system to a world coordinate system by using a body odometer pose estimate
$$( {R}_{b}^{w} , {t}_{b}^{w} )$$
and a pose transformation
$$( {R}_{s}^{b} + {t}_{s}^{b} )$$
obtained through calibration from a body coordinate system to the sensor coordinate system, wherein a world coordinate value of the measurement point is p^{w}:
$${p}^{w} = {R}_{b}^{w} ( {R}_{s}^{b} {p}^{s} + {t}_{s}^{b} ) + {t}_{b}^{w}$$
S2: mapping the measurement point from the world coordinate system to a corresponding grid thereof in an elevation map, wherein a corresponding elevation value thereof is a z-axis component of a measurement point
$${p}^{w} = ( {p}_{x}^{w} , {p}_{y}^{w} , {p}_{z}^{w} ) ,$$
i.e., an elevation measurement value of a current grid, and the elevation measurement value satisfies a Gaussian distribution
$$\tilde{h} ∼ N ( {μ}_{\tilde{h}} , {σ}_{\tilde{h}}^{2} ) ;$$
and constructing a projection matrix M_{D}=[0,0,1] to obtain a current elevation measurement mean value:
$${μ}_{\tilde{h}} = {M}_{p} {p}^{w} = {M}_{p} [ {R}_{b}^{w} ( {R}_{s}^{b} {p}^{s} + {t}_{s}^{b} ) + {t}_{b}^{w} ]$$
computing a variance of a current elevation measurement value from covariance propagation:
$${σ}_{\tilde{h}}^{2} = {J}_{p} {Σ}_{p} {J}_{p}^{T} + {J}_{R} {Σ}_{R} {J}_{R}^{T} + {J}_{t} {Σ}_{t} {J}_{t}^{T}$$
where Jᵥ, J_{R}, and Jₜ are Jacobian matrices of the elevation measurement value \tilde{h} with respect to p^{s},
$${R}_{b}^{w} , and {t}_{b}^{w} ;$$
Σᵥ is a covariance matrix of the measurement point in the sensor coordinate system; Σ_{R} is a covariance matrix of a robot odometer rotation; Σₜ is a covariance matrix of a robot odometer translation;
S3: constructing a Gaussian distribution of the current elevation measurement value according to variances of the current elevation measurement mean value and the current elevation measurement value;
in a case that elevation estimates of grids satisfy the Gaussian distribution
$$\tilde{h} ∼ N ( {μ}_{\tilde{h}} , {σ}_{\tilde{h}}^{2} ) ,$$
fusing the current elevation measurement into an elevation estimate of the current grid by computing a normalized product of two Gaussian distributions to obtain an updated elevation estimate:
$${μ}_{\tilde{h}} = \frac{{σ}_{\tilde{h}}^{2} {μ}_{\tilde{h}} + {σ}_{\tilde{h}}^{2} {μ}_{\tilde{h}}}{{σ}_{\tilde{h}}^{2} + {σ}_{\tilde{h}}^{2}}$$
$${σ}_{\tilde{h}}^{2} = \frac{{σ}_{\tilde{h}}^{2} {σ}_{\tilde{h}}^{2}}{{σ}_{\tilde{h}}^{2} + {σ}_{\tilde{h}}^{2}}$$
S4: constructing a dense elevation map for the motion planning of the legged robot according to the updated elevation estimate.

6. The elevation map construction method for the motion planning of the legged robot according to claim 5, wherein
mapping the measurement point from the world coordinate system to a corresponding grid thereof in an elevation map, i.e., mapping the measurement point p^{w} from the world coordinate system to obtain a two-dimensional array index
$$( {I}_{x}^{a} , {I}_{y}^{a} )$$
to which the corresponding grid thereof in the elevation map belongs, comprises the following steps:
step one: letting the measurement point in the world coordinate system be
$${p}^{w} = [ {p}_{x}^{w} , {p}_{y}^{w} , {p}_{z}^{w} ] ,$$
respectively dividing x and y components thereof by a map resolution r, and performing rounding-down to obtain a 2D integer index of the corresponding grid of the measurement point in the world coordinate system:
$$\{ \begin{matrix}{I}_{x}^{w} = ⌊ {p}_{x}^{w} / r ⌋ \\ {I}_{y}^{w} = ⌊ {p}_{y}^{w} / r ⌋\end{matrix}$$
step two: letting a 2D integer index of an origin of a current map coordinate system in the world coordinate system be
$$[ {I}_{{m}_{x}}^{w} , {I}_{{m}_{y}}^{w} ] ,$$
and computing a 2D integer index of a corresponding grid of the measurement point in a map coordinate system:
$$\{ \begin{matrix}{I}_{x}^{m} = {I}_{x}^{w} - {I}_{{m}_{x}}^{w} \\ {I}_{y}^{m} = {I}_{y}^{w} - {I}_{{m}_{y}}^{w}\end{matrix}$$
step three: letting the elevation map be a grid map with a size of N×N, and determining whether a current point is within an elevation map range by determining whether an index of the current point simultaneously satisfies the following two conditions:
$$\{ \begin{matrix}{I}_{x}^{m} ∈ [ 0 , N ) \\ {I}_{y}^{m} ∈ [ 0 , N )\end{matrix}$$
step four: in a case that the measurement point simultaneously satisfies the two conditions, i.e., the measurement point is within the map range, performing a modulo operation on the 2D integer index in the world coordinate system to a map size N, and mapping the measurement point to a two-dimensional array index stored in a computer:
$$\{ \begin{matrix}{I}_{x}^{a} = {I}_{x}^{w} {mod}^{N} \\ {I}_{y}^{a} = {I}_{y}^{w} {mod}^{N}\end{matrix}$$
step five: changing an index mapping step to a binary form with high computational efficiency, i.e., changing the modulo operation “mod” to binary bitwise and operation “&”, by setting the length and width of the elevation map to exponents of 2 with the same magnitude, i.e., N=2ⁿ:
$$\{ \begin{matrix}{I}_{x}^{a} = {I}_{x}^{w} \& ( {2}^{n} - 1 ) \\ {I}_{y}^{a} = {I}_{y}^{w} \& ( {2}^{n} - 1 )\end{matrix} .$$

7. The elevation map construction method for the motion planning of the legged robot according to claim 6, wherein
performing motion distortion removal on the measurement point p^{s} in the sensor coordinate system comprises the following steps:
A1: putting a current frame of point clouds with a timestamp into a point cloud queue, and putting a robot odometer pose with a timestamp into an odometer queue; in a case that a current point cloud queue is not empty, traversing the odometer queue from front to back, and maintaining a queue first frame timestamp of the odometer queue aligned with a point cloud start point timestamp;
A2: for the current frame of point clouds, letting a timestamp of a start point be tₑ, letting a timestamp of an end point be tₑ, and using the timestamp of the end point as a timestamp of the current frame of point clouds, denoted as t_{c}=tₑ;
A3: traversing the odometer queue from front to back, and finding out adjacent two frames of odometer poses just before and after a point cloud timestamp, wherein the adjacent two frames of odometer poses are respectively
$${T}_{b}^{w} ( {t}_{k} ) and {T}_{b}^{w} ( {t}_{k + 1} ) ,$$
satisfying tₖ≤t_{c}<tₖ₊₁; then computing a robot odometer pose at the point cloud timestamp through a linear interpolation method:
$${T}_{b}^{w} ( {t}_{c} ) = \frac{{t}_{k + 1} - {t}_{c}}{{t}_{k + 1} - {t}_{k}} {T}_{b}^{w} ( {t}_{k} ) + ( 1 - \frac{{t}_{k + 1} - {t}_{c}}{{t}_{k + 1} - {t}_{k}} ) {T}_{b}^{w} ( {t}_{k + 1} ) ;$$
A4: traversing each point in the point cloud queue backwards from the start point according to the timestamp, wherein a currently traversed original measurement point is
$${p}_{a}^{s}$$
and a timestamp thereof is tᵥ, and performing linear interpolation on the adjacent two frames of odometer poses at the time to obtain a robot odometer pose at a time corresponding to the measurement point, denoted as
$${T}_{b}^{w} ( {t}_{v} ) ;$$
A5: transforming the original measurement point
$${p}_{a}^{s}$$
Irom the sensor coordinate system at a time tᵥ to a sensor coordinate system at a unified time corresponding to the timestamp t_{c} of the current frame of point clouds through pose transformation:
$${p}_{b}^{s} = {[ {T}_{b}^{w} ( {t}_{c} ) {T}_{s}^{b} ]}^{- 1} {T}_{b}^{w} ( {t}_{p} ) {T}_{z}^{b} {p}_{a}^{s}$$
thus obtaining a current frame of point clouds
$${P}_{b}^{s}$$
with motion distortion removed.

8. The elevation map construction method for the motion planning of the legged robot according to claim 7, wherein
performing trailing point cloud removal on the current frame of point clouds
$${P}_{b}^{s}$$
comprises the following steps:
B1: computing polar coordinates of a point p^{s} in the point clouds in the sensor coordinate system:
$$\{ \begin{matrix}{s}_{r} = \sqrt{{( {p}_{x}^{s} )}^{2} + {( {p}_{y}^{s} )}^{2} + {( {p}_{z}^{s} )}^{2}} \\ {s}_{p} = arc cos ( {p}_{z}^{s} / {s}_{r} ) \\ {s}_{a} = arc tan ( {p}_{y}^{s} / {p}_{x}^{s} )\end{matrix}$$
where sᵣ is a length of a vector p^{s}, sᵥ is an included angle between the vector p^{s} and a positive direction of a Z-axis of the sensor coordinate system, and s_{α} is an included angle between a projection vector of the vector p^{s} in an XY plane of the sensor coordinate system and a positive direction of an X-axis;
B2: in a polar coordinate system, projecting all points onto a spherical surface with sᵥ=1, and then selecting a specific rectangular area of the spherical surface to remove a trailing point cloud projected thereto:
$$\{ \begin{matrix}{s}_{p} ∈ [ {s}_{{p}_{min}} , {s}_{{p}_{max}} ] \\ {s}_{a} ∈ [ {s}_{{a}_{min}} , {s}_{{a}_{min}} ]\end{matrix}$$
performing leg point cloud removal on the current frame of point clouds
$${P}_{b}^{s}$$
comprises the following steps:
C1: projecting a position Aₒ of a knee joint in the sensor coordinate system and a position Bₒ of a foot end in the sensor coordinate system onto a spherical surface with a radius of 1 in the sensor coordinate system; letting two points after projection be respectively A and B, then obtaining:
$$SA = \frac{{SA}_{o}}{\vert {SA}_{o} \vert}$$
$$SB = \frac{{SB}_{o}}{\vert {SB}_{o} \vert}$$
constructing a set of standard orthogonal bases from vectors SA and SB:
$$\{ \begin{matrix}{b}_{x} = SA \\ {b}_{z} = SN = SA \times SB \\ {b}_{y} = SF = {b}_{z} \times SA\end{matrix}$$
C2: letting a foot of a perpendicular of a point P projected onto an XY plane of the standard orthogonal bases be H=[hₓ, h_{y}, h_{z}]^{T}, then the foot of the perpendicular being:
$$\{ \begin{matrix}{h}_{x} = SP \cdot SA \\ {h}_{y} = SP \cdot SF \\ {h}_{z} = SP \cdot SN\end{matrix}$$
under the standard orthogonal bases, computing spherical coordinates (1, θ, φ) of a laser point P:
$$\{ \begin{matrix}θ = ∠ NSP = arccos ( SP \cdot SN ) \\ ϕ = ∠ ASH = arctan ( {h}_{y} / {h}_{x} )\end{matrix}$$
C3: assuming that a projection of a leg link is a rectangle on a normalized spherical surface, determining whether the point P is within the rectangle range through the following formula:
$$\{ \begin{matrix}0.5 π - θ ∈ ( - 0.5 b , 0.5 b ) \\ ϕ ∈ ( 0 , l )\end{matrix}$$
where b is the maximum width of the leg link after projection and l is the maximum length of the leg link after projection; in a case that the point P is within the rectangle range, removing the point P.

9. An elevation map construction method for motion planning of a legged robot,
comprising the following steps:
acquiring original measurement point data of a map planning area;
performing pose transformation on the original measurement point data to obtain a current frame of point clouds with motion distortion removed;
performing processing on the current frame of point clouds to remove points unrelated to environmental information therein to obtain preprocessed point clouds, wherein
the points unrelated to the environmental information comprise a body point cloud or/and a leg point cloud or/and a noise point cloud;
performing processing on the preprocessed point clouds according to body odometer and/or visual odometer and/or laser odometer pose data to obtain a grid elevation value; and
establishing or updating grids in the map planning area according to the grid elevation value to achieve elevation map construction for the motion planning of the legged robot.

10. An elevation map construction system for motion planning of a legged robot,
comprising a laser radar, a motion distortion removal module, a point cloud filtering module, an elevation map module, one or more processors, and a storage apparatus, wherein
the laser radar is configured to acquire original measurement point data;
the motion distortion removal module is configured to perform processing on the original measurement point data according to transformation characteristics of a reference coordinate system to transform the original measurement point data from a sensor coordinate system at a certain time to a sensor coordinate system at a unified time to obtain a current frame of point clouds with motion distortion removed;
the point cloud filtering module is configured to perform processing on the current frame of point clouds to remove points unrelated to environmental information therein to obtain preprocessed point clouds;
the elevation map module is configured to perform processing on the preprocessed point clouds to obtain a grid elevation value; and updating corresponding grids of the preprocessed point clouds in an elevation map;
the storage apparatus is configured to store a program of one or more modules;
the program, when executed by the one or more processor, causes the one or more processor to implement the elevation map construction method for the motion planning of the legged robot according to claim 1.

11. A computer-readable storage medium,
comprising a computer program stored therein, wherein the program, when executed by a processor, implements the elevation map construction method for the motion planning of the legged robot according to claim 1.
